(19) United States
(12) Patent Application Publication
(10) Pub. No.: US 2010/0225704 A1
(43) Pub. Date: Sep. 9, 2010

(54) LIQUID EJECTING APPARATUS AND LIQUID HOUSING CONTAINER

(75) Inventors: Yuji AOKI, Matsumoto-shi (JP); Hitotoshi KIMURA, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Shinjuku-ku (JP)

(21) Appl. No.: 12/706,941

(22) Filed: Feb. 17, 2010

(30) Foreign Application Priority Data
Mar. 6, 2009 (JP) 2009-053785

(51) Int. Cl. B41J 2/14

(52) U.S. Cl. 347/50

(57) ABSTRACT

A liquid ejecting apparatus includes a liquid housing container that is housed by a container housing portion. The container housing portion includes a first terminal connecting to the liquid housing container. A position determining pin defines an insertion direction in which the liquid housing container is inserted into the container housing portion. The liquid housing container includes a circuit substrate and a second terminal connecting to the first terminal. A position determining hole determines the position of the liquid housing container by inserting the position determining pin therein. An inclination portion is configured such that the first terminal first contacts a member disposed on a substrate mounting face, on which the circuit substrate is installed, of faces of the liquid housing container, by inserting the position determining pin into the position determining hole along the inclination portion when the liquid housing container is inserted into the container housing portion.

### BACKGROUND

1. Technical Field

The present invention relates to a liquid ejecting apparatus and a liquid housing container.

2. Related Art

In an ink jet printing apparatus as an example of a liquid ejecting apparatus, typically, an ink cartridge that is a detachable liquid housing container is installed. There are ink cartridges in which a circuit substrate having a memory element is mounted. In the memory element, for example, various types of information such as the amount of ink inside the ink cartridge and the colors of ink are stored. By connecting a terminal disposed on the circuit substrate of the ink cartridge and a terminal disposed on a main body side of the printing apparatus to each other, the printing apparatus reads or writes (access) information stored in the memory element of the ink cartridge.

Generally, when an ink cartridge is inserted into a cartridge holder (container housing portion) of the printing apparatus, the terminal disposed on the cartridge holder side is brought into contact with a corner portion of the ink cartridge. Then, the circuit substrate of the ink cartridge continues to slide on a container face that is grounded. Then, finally, the terminal disposed on the cartridge holder side is brought into contact with the terminal disposed on the circuit substrate. Accordingly, a corner portion of the ink cartridge or the container face located on the front side of the circuit substrate may be grinded, and grinding powers are generated. As a result, there is a problem that defective contact between terminals due to the grinding powers occurs. A technology regarding such a problem, JP-A-2007-290363 has been disclosed. However, in such typical technology, suppression of generation of grinding powers has not been sufficiently considered. Furthermore, decreasing the generation of the powers is demanding.

In addition, such a problem is not limited to relationship between a printing apparatus and an ink cartridge and, generally, is a problem common to relationship between a liquid ejecting apparatus main body and a liquid housing container having a terminal for communicating with the liquid ejecting apparatus.

Examples of related arts are JP-A-2007-266618 and JP-A-2003-152297.

### SUMMARY

An advantage of some aspects of the invention is that it provides technology for suppressing occurrence of defective contact between terminals by suppressing generation of grinding powders due to grind of a liquid housing container.

The invention may be implemented in the following forms or applications.

### Application 1

There is provided a liquid ejecting apparatus that ejects liquid, the liquid ejecting apparatus including: a liquid housing container that houses the liquid; and a liquid ejecting apparatus main body having a container housing portion that houses the liquid housing container. The container housing portion includes: a first terminal that is used for electrical connection to the liquid housing container; and a position determining pin that has a shape expanding in an insertion direction in which the liquid housing container is inserted into the container housing portion and determines the position of the liquid housing container. The liquid housing container includes: a circuit substrate that has a face approximately parallel to the insertion direction and has a second terminal that is electrically connected to the first terminal by being brought into contact with each other; and a position determining hole that determines the position of the liquid housing container by inserting the position determining pin therein. An inclination portion that is disposed to be inclined with respect to the insertion direction is formed in at least one of the position determining pin and the position determining hole. The inclination portion is configured such that the first terminal is brought into contact first with a member disposed on a substrate mounting face, on which the circuit substrate is installed, of faces of the liquid housing container by inserting the position determining pin into the position determining hole along the inclination portion when the liquid housing container is inserted into the container housing portion.

According to the liquid ejecting apparatus of Application 1, the first terminal does not have a portion corresponding to a corner portion of the liquid housing container. Accordingly, defective connection between terminals can be suppressed by suppressing generation of grinding powders due to grind of the liquid housing container.

### Application 2

In the liquid ejecting apparatus of Application 1, the inclination portion is configured such that a target that is brought into contact first with the first terminal is the second terminal when the liquid housing container is inserted into the container housing portion.

According to the liquid ejecting apparatus of Application 2, the first terminal is not brought into contact with anything but the second terminal. Accordingly, defective connection between terminals can be suppressed by suppressing generation of grinding powders further.

In addition, the invention may be implemented in various forms. For example, the invention may be implemented as a form of method of inserting a liquid housing container into a liquid ejecting apparatus main body or the like.

### BRIEF DESCRIPTION OF THE DRAWINGS

The invention will be described with reference to the accompanying drawings, wherein like numbers reference like elements.

FIG. 1 is a schematic diagram showing the configuration of a liquid ejecting apparatus according to an embodiment of the invention.

FIG. 2 is a perspective view of a container holder, in which liquid housing holders are installed, viewed from the upper side of the slope of the container holder.

FIG. 3 is a perspective view of the container holder shown in FIG. 2, viewed from the lower side of the slope of the container holder.

FIG. 4 is a front view of the container holder shown in FIG. 2.

FIG. 5 is an exploded perspective view of the container holder shown in FIG. 2.

FIG. 6A is a perspective view showing a lever member and a spring, viewed from a cartridge side.

FIG. 6B is a perspective view of a device-side fixation structure, viewed from a side opposite to the cartridge.

FIG. 6C is a cross-sectional view of the periphery of the device-side fixation structure.

FIG. 7 is a front view of a container holder in which liquid housing containers are installed.

FIG. 8 is a front view of a container holder from which some liquid housing containers are detached.

FIG. 9 is a perspective view of a liquid housing container, viewed from the side of one side face thereof.

FIG. 10 is an exploded perspective view of the liquid housing container shown in FIG. 9.

FIG. 11 is an arrow view taken along line XI-XI shown in FIG. 8.

FIG. 12 is a perspective view of the liquid housing container, viewed from the side of the other side face.

FIG. 13 is an enlarged diagram of portion XIII shown in FIG. 12.

FIG. 14 is an enlarged plan view of a guide groove shown in FIG. 13.

FIG. 15A is a plan view of a front end face of an ink cartridge.

FIG. 15B is an arrow view of line XVB-XVB shown in FIG. 15A.

FIG. 16 is an explanatory diagram schematically illustrating a procedure of inserting an ink cartridge into a cartridge holder.

FIG. 17 is an explanatory diagram schematically illustrating a procedure of inserting an ink cartridge into a cartridge holder.

FIG. 18 is an explanatory diagram schematically illustrating a procedure of inserting an ink cartridge into a cartridge holder.

FIG. 19 is an explanatory diagram schematically illustrating a procedure of inserting an ink cartridge into a cartridge holder.

FIG. 20 is an explanatory diagram schematically illustrating a procedure of inserting an ink cartridge into a cartridge holder according to a second embodiment of the invention.

FIG. 21 is an explanatory diagram schematically illustrating a procedure of inserting an ink cartridge into a cartridge holder according to the second embodiment.

FIG. 22 is an explanatory diagram schematically illustrating a procedure of inserting an ink cartridge into a cartridge holder according to the second embodiment.

FIG. 23 is an explanatory diagram schematically illustrating a procedure of inserting an ink cartridge into a cartridge holder according to the second embodiment.

FIGS. 24A and 24B are explanatory diagrams schematically illustrating a procedure of inserting an ink cartridge into a cartridge holder according to a third embodiment of the invention.

### DESCRIPTION OF EXEMPLARY EMBODIMENTS

Next, embodiments of the invention will be described in the following order.

### A. First Embodiment

### B: Second Embodiment

### C: Third Embodiment

### D: Modified Examples

### A. First Embodiment

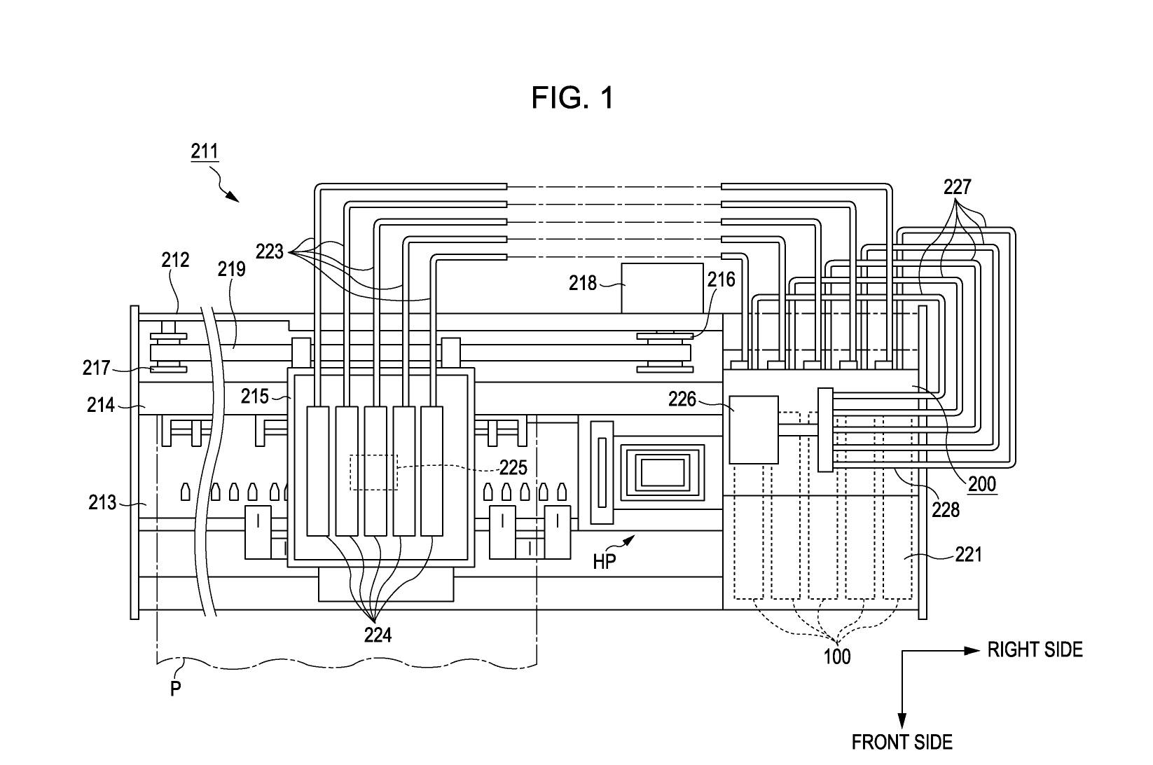

FIG. 1 is a schematic diagram showing the configuration of a liquid ejecting apparatus according to an embodiment of the invention. An ink jet printing apparatus 211 as a liquid ejecting apparatus according to this embodiment, as shown in FIG. 1, includes a main body case 212 having an approximately rectangular box shape. In the lower part inside the main body case 212 on the front side, a platen 213 is disposed along the longitudinal direction (the horizontal direction in FIG. 1), which is the main scanning direction, of the main body case 212. The platen 213 is a support board that supports a printing sheet P as a target. On the platen 213, a printing sheet P is transported in the sub scanning direction perpendicular to the main scanning direction by a paper transport mechanism not shown in the figure.

Inside the main body case 212, above the rear portion of the platen 213, a guide shaft 214 having a stick shape is disposed. A carriage 215 is supported by the guide shaft 214 so as to be movable along the guide shaft 214.

In addition, in positions on a side face located on the rear side of the main body case 212 that correspond to both end portions of the guide shaft 214, a driving pulley 216 and a driven pulley 217 are supported so as to be rotatable. A carriage motor 218 is connected to the driving pulley 216, and an endless-shaped timing belt 219 supporting the carriage 215 is disposed to hang between one pair of pulleys 216 and 217. Accordingly, the carriage 215 can reciprocate in the main scanning direction along the guide shaft 214 in accordance with the driving of the carriage motor 218.

On one end side (the right-end side in FIG. 1) inside the main body case 212, a cartridge holder 200 as a container holder having a box shape is disposed. A portion corresponding to the front wall and a front portion of the upper wall of the cartridge holder 200 is configured as an opening portion 221 that can be opened or closed. A user can detach, attach, or replace an ink cartridge 100 as a liquid housing container by setting the opening portion 221 to be in the open state. In other words, in the cartridge holder 200, a plurality of (in this embodiment, five) the ink cartridges 100 arranged for each color of ink as liquid is configured to be attached or detached in accordance with an insertion or separation operation in the front-to-rear or rear-to-front direction under the open state of the opening portion 221.

When being installed into the cartridge holder 200, each ink cartridge 100 is connected to the upstream end of an ink supply path 223 corresponding thereto. In addition, the downstream end of each ink supply path 223 is connected to the upstream side of a valve unit 224 that is mounted on the carriage 215. The downstream side of the valve unit 224 is connected to a print head 225 as a liquid ejecting head disposed on the lower face side of the carriage 215. The ink supply paths 223 and the valve units 224 configure a liquid supply mechanism that supplies liquid supplied from the ink cartridges 100 to the print heads 225.

Between the cartridge holder 200 and the platen 213, a home position HP that is a shelter position of the print head 225 is disposed. Before the start of printing or the like, various maintenance processes such as a cleaning process are performed for the print heads 225 in the home position HP.

Inside the main body case 212, in a position located on the upper side of the cartridge holder 200, a compression pump 226 is disposed. The compression pump 226 is a supply source of pressurized air (pressurized fluid) and is connected to the upstream end of a compression air supply path 227. The compression air supply path 227 is divided into branches of which the number is the same as that of the ink cartridges 100 in a position in which a distributor 228 disposed on the downstream side of the compression pump 226 is located. The lower ends of the branched compression air supply paths 227 are connected to the ink cartridges 100. The compression pump 226, the compression air supply path 227, and the distributor 228 configure a compression fluid supply mechanism that supplies pressurized fluid to the ink cartridges 100. In this embodiment, air is used as the compression fluid. However, a gas, liquid, or the like other than air may be used.

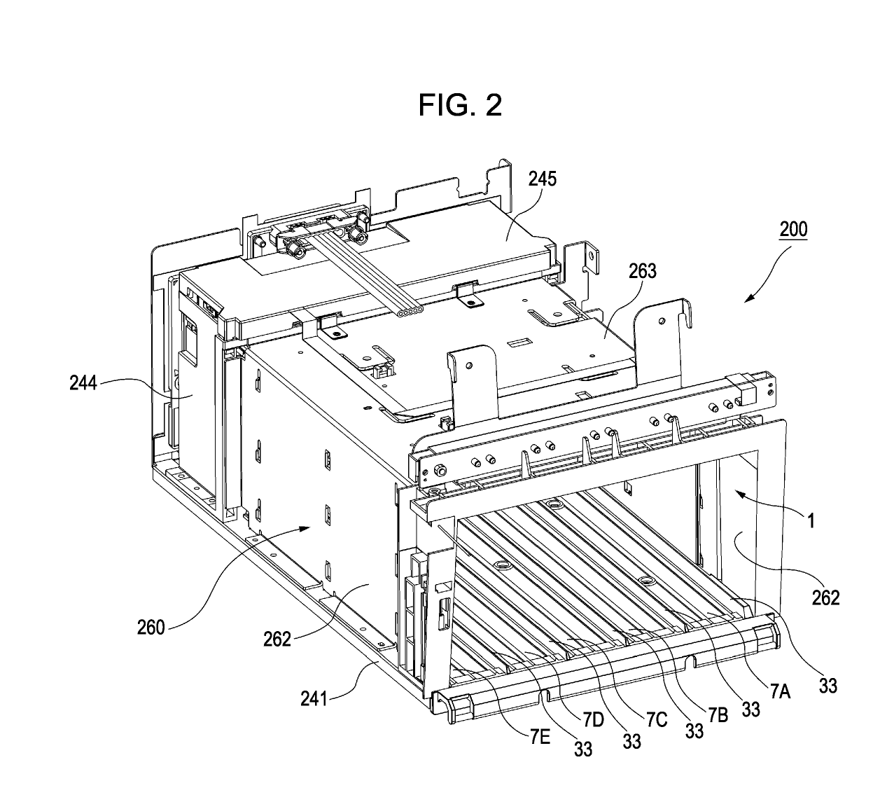

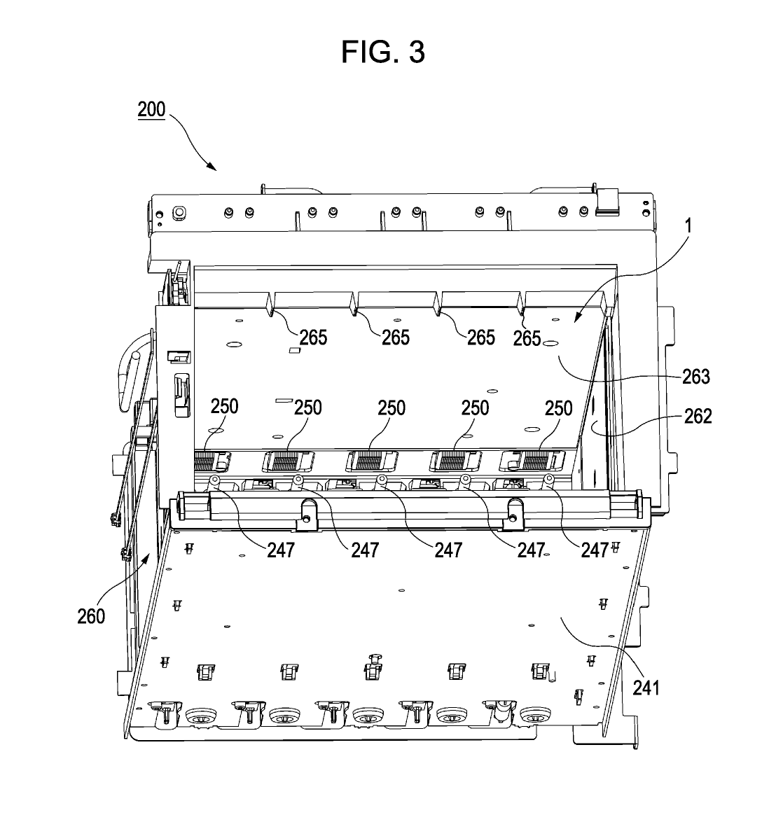

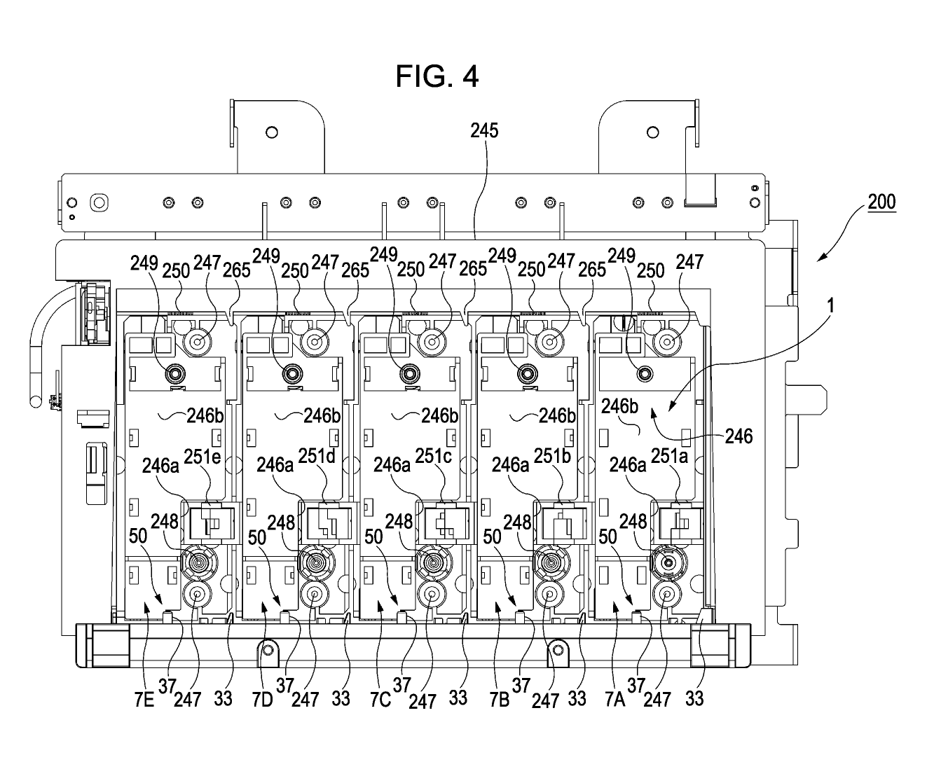

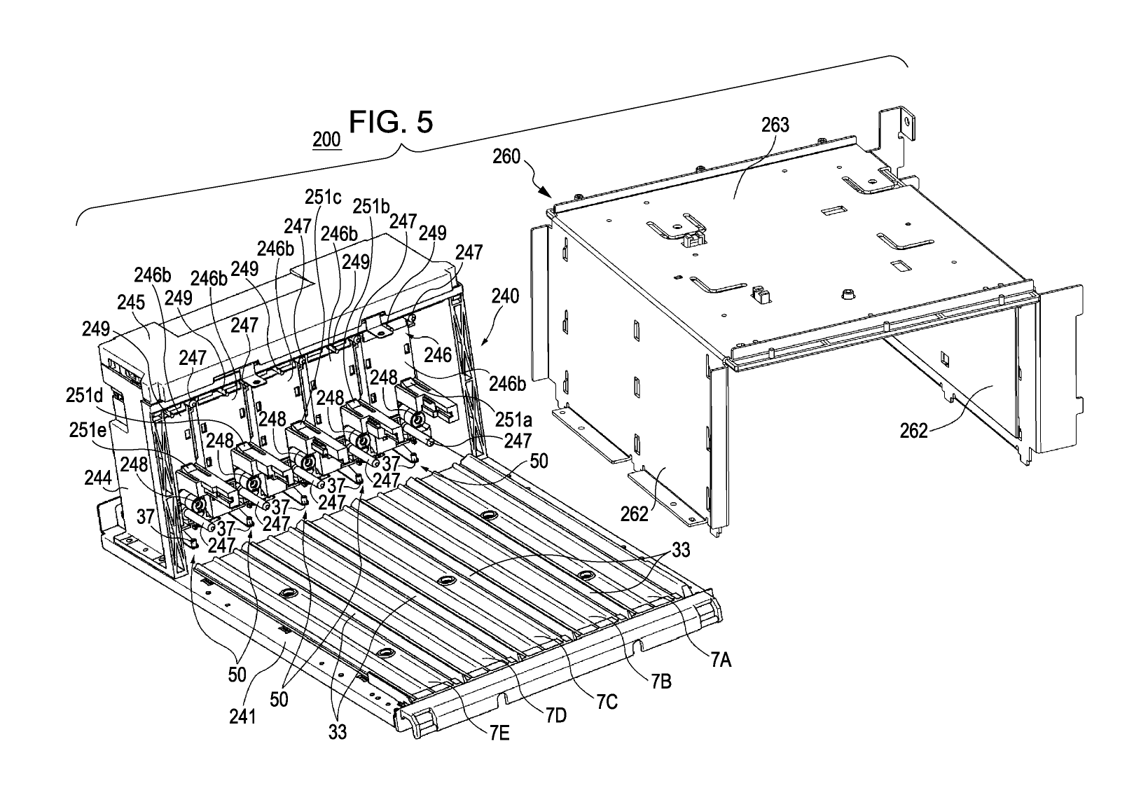

FIG. 2 is a perspective view of the container holder, in which the liquid housing holders are installed, viewed from the upper side of the slope of the container holder. FIG. 3 is a perspective view of the container holder shown in FIG. 2, viewed from the lower side of the slope of the container holder. In addition, FIG. 4 is a front view of the container holder shown in FIG. 2. FIG. 5 is an exploded perspective view of the container holder shown in FIG. 2.

As shown in FIGS. 2 to 5, the cartridge holder 200 is configured by a holder main body 240 that has an approximately “L” shape on the side view and a casing 260 that has a cross-section in a “U” shape.

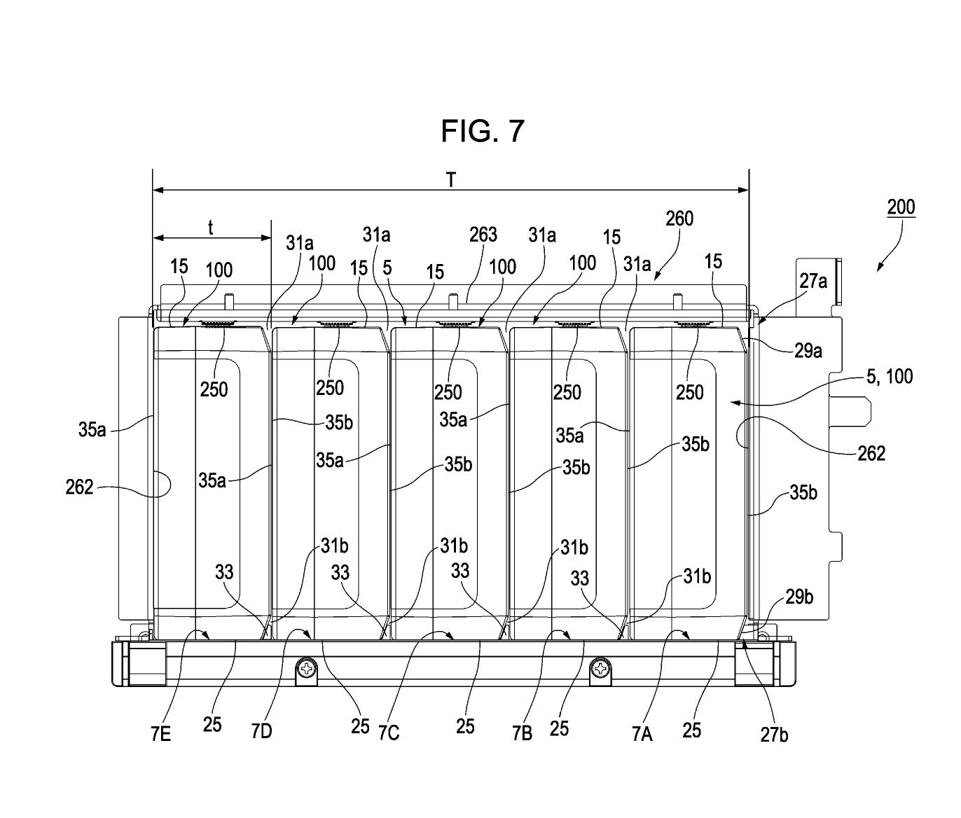

The casing 260, as shown in FIGS. 5 and 7, has one pair of support side walls 262 and 262 and a top wall 263 that connects the upper end edges of the support walls 262 and 262. By press-molding a metal plate, the casing 260 is formed as one body.

The holder main body 240, as shown in FIG. 5, has a substrate 241 that is formed in a rectangular shape on the plan view by molding a resin material or a metal material and a wall body 244 that is mounted on the rear surface of the substrate 241.

The substrate 241 is a support board that is used for placing the ink cartridges 100 in a parallel arrangement when the ink cartridges 100 are installed to the cartridge holder 200. On the substrate 241, a plurality of guide rails 33 as first guide protrusions is disposed to be aligned so as to extend to the front and rear sides. The guide rail 33 is used for guiding the ink cartridge 100 when the ink cartridge 100 is attached to or detached from the holder 200. Inside the cartridge holder 200, five cartridge slots 7A, 7B, 7C, 7D, and 7E are partitioned by the guide rails 33. The cartridge slots 7A to 7E serve as container installation portions in which the ink cartridges 100 of each color are individually housed.

The wall body 244 is a molded member having a “U” shape on the plan view. The wall body 244 is mounted on the substrate 241 so as to face an opening on the front side. On the surface of the wall body 244, a top plate 245 molded in a rectangular shape is mounted.

The wall body 244 includes a rear face not shown in the figure. The wall body 244 includes a slider member 246 that has a face 246b disposed to be approximately parallel to the rear face of the wall body 244. The slider member 246 is biased toward the front side, that is, in a direction opposite to the insertion direction of the ink cartridge 100 by a biasing member not shown in the figure. The face 246b of the slider member 246 forms the inner end faces of the cartridge slots 7A to 7E. The slider member 246 is located on the front side by a force applied by the basing member in a case where the ink cartridges 100 are not installed to the cartridge slots 7A to 7E.

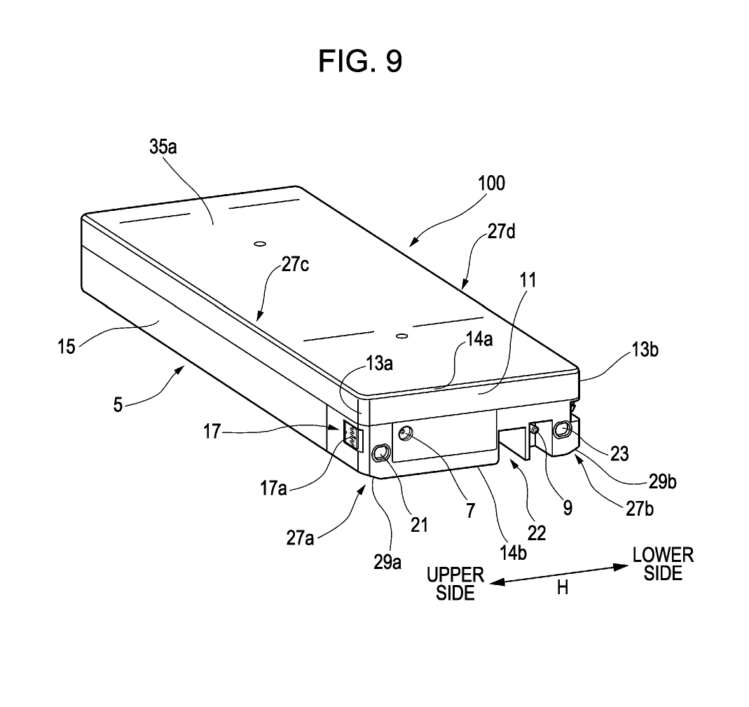

When the ink cartridge 100 is inserted into each of the cartridge slots 7A to 7E, the slider member 246 is pressed by the front end face 11 (see FIGS. 9, 11, and 12) of the ink cartridge 100 so as to move to the rear side.

When the ink cartridge 100 is completely installed to each of the cartridge slots 7A to 7E, the slider member 246 is stopped in a predetermined position. The slider member 246 applies a biasing force for the installed ink cartridge 100 in the direction opposite to the insertion direction all the time by the force applied by the biasing member even in a case where the ink cartridge 100 is installed to each of the cartridge slots 7A to 7E. This biasing force operates so as to press the ink cartridge to the front side when the ink cartridge 100 is detached from each of the cartridge slots 7A to 7E.

In the slider member 246, a pair of position determining pins 247 and 247 disposed on the rear face of the wall body 244, an air communication opening 248, an ink supply pin 249, and an opening portion 246a used for exposing identification members 251a to 251e to the front side on the rear face of the wall body 244 are disposed.

On the rear face of the wall body 244, that is, the inner end faces of the cartridge slots 7A to 7E, the pair of position determining pins 247 and 247, the air communication opening 248, the ink supply pin 249, and the identification members 251a to 251e are disposed so as to be exposed to the front side through the opening portion 246a of the slider member 246.

All the one pair of position determining pins 247 and 247, the air communication opening 248, the ink supply pin 249, and the identification members 251a to 251e operate when the ink cartridge 100 is installed to each of the cartridge slots 7A, 7B, 7C, 7D, and 7E located on the substrate 241 on the front face of the slider member 246 that is the inner end faces of the container installation portions 1.

The one pair of the position determining pins 247 and 247 is used for determining the positions of the ink cartridges 100. The one pair of the position determining pins 247 and 247 is disposed above and below the inner end faces of the cartridge slots 7A to 7E, respectively.

The air communication opening 248 is used for supplying the air to the ink cartridges 100. The air communication opening 248 is disposed below the inner end face of each of the cartridge slots 7A to 7E. In addition, the air communication opening 248 is disposed in a position for being pinched by one pair of the position determining pins 247 and 247 and in a position close to the lower-side position determining pin 247.

The ink supply pin 249 is used for supplying ink from the ink cartridge 100 to the print head 225 (see FIG. 1) through the ink supply path 223 (see FIG. 1). The ink supply pin 249 is disposed above the inner face of each of the cartridge slots 7A to 7E. In addition, the ink supply pin 249 is disposed in a position not for being pinched by the one pair of position determining pins 247 and in a position close to the upper-side position determining pin.

The identification members 251a to 251e are used for preventing incorrect installation of the ink cartridge 100. The identification members 251a to 251e are disposed below the inner end faces of the cartridge slots 7A to 7E. In addition, the identification members 251a to 251e are disposed in positions for being pinched by one pair of position determining pins 247 and 247 and in positions right above the air communication opening 248. In other words, the identification members 251a to 251e are disposed in positions for being pinched by the upper-side position determining pin 247 and the air communication opening 248 and in a position close to the air communication opening 248.

A plurality of (five in this embodiment) identification members 251a, 251b, 251c, 251d, 251e is disposed from positions right above the air communication openings 248 so as to export the front end portions to the front side through notch portions 246a formed by being notched by a cover plate 246 from the lower side.

The identification members 251a to 251e have a center-hollow pillar shape of which the rear end face, which becomes a base end, is open and extends to the front and rear sides. In the front end of each of the identification members 251a to 251e, a concavo-convex fitting portion is formed. On the other hand, on the front end face of the ink cartridge 100 in the insertion direction, an identification portion 22 (see FIG. 9) corresponding to the shape of the concavo-convex fitting portion of each of the identification members 251a to 251e is formed. Although not shown in detail in the figure, the shape of the identification portion 22 varies depending on the type of the ink cartridge 100.

In addition, the concavo-convex fitting portion of each of the identification members 251a to 251e has a shape that can be fitted only with the identification portion 22 of one type of the ink cartridge 100 and cannot be fitted with the identification portion 22 of any other type of the ink cartridge 100. As described above, by using combinations between identification portions 22 of the ink cartridges and the concavo-convex fitting portions of the identification members 251a to 251e, the ink jet printing apparatus of this embodiment is configured so as to prevent incorrect installation of the ink cartridges 100.

As shown in FIGS. 3 and 4, on an opposing face of the top plate 245 of the wall body 244, that is, the front face of each of the cartridge slots 7A to 7E, a guide protrusion 265 having a triangular cross-section as a second guide protrusion is disposed on the front side, and a device-side terminal 250 is disposed on the inner side.

The guide protrusion 265 is disposed so as to face the guide rail 33. The second guide protrusion 265, similarly to the guide rail 33, is used for guiding the ink cartridge 100 when the ink cartridge 100 is attached to or detached from one of the cartridge slots 7A to 7E of the holder 200.

In addition, the device-side terminal 250 is brought into contact with a contact point 17a (see FIG. 9) of an electrode of a circuit substrate 17 (see FIG. 9) installed to the ink cartridge 100 so as to electrically connected to the electrode so as to be conductive with each other when the ink cartridge 100 is installed to one of the cartridge slots 7A to 7E.

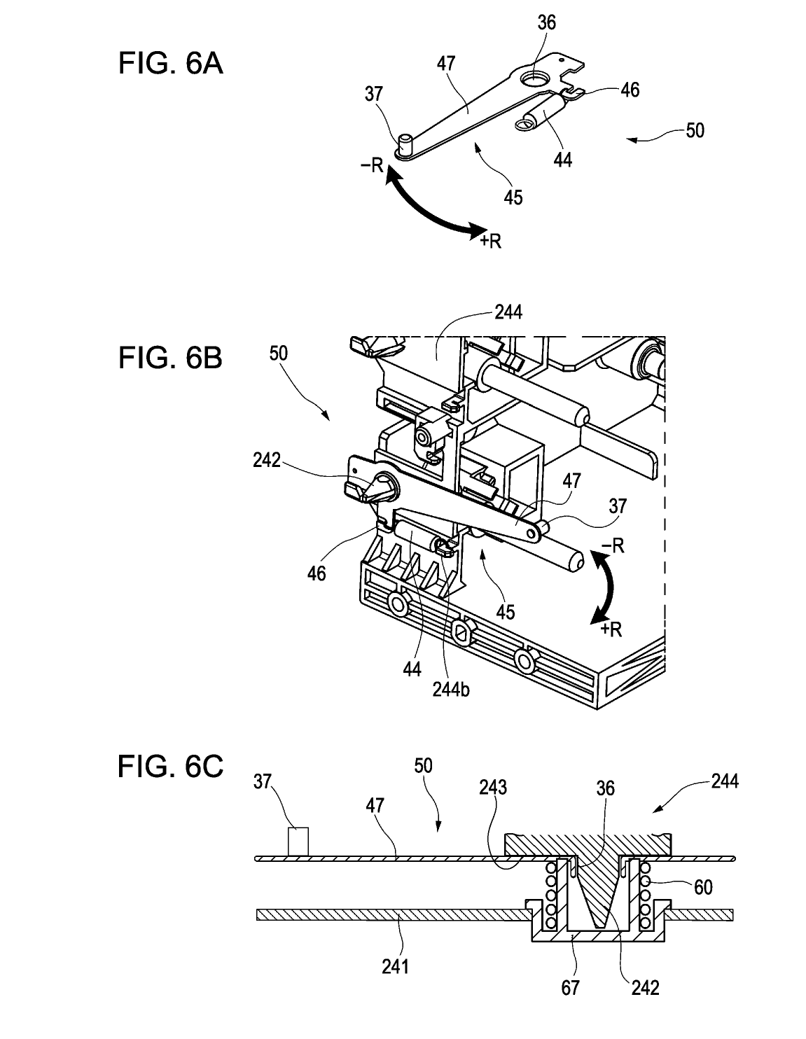

Below each of the cartridge slots 7A to 7E and on the rear side (back side) of the cartridge slot, a device-side fixation structure 50 is disposed. FIG. 6A is a perspective view showing a lever member 45 and a spring 44 that configure the device-side fixation structure 50, viewed from the cartridge 100 side. FIG. 6B is a perspective view of the device-side fixation structure 50, viewed from a side opposite to the cartridge 100. In addition, FIG. 6C is a cross-sectional view of the periphery of the device-side fixation structure 50.

As shown in FIG. 6C, the device-side fixation structure 50 includes the lever member 45 that expands to be almost in parallel with the substrate 241, that is, the lower face of the cartridge slots 7A to 7E (see FIG. 3).

The lever member 45 includes a thin and long lever main body 47 having elasticity, a shaft hole 36 disposed on a base end portion of the lever main body 47, and a locking pin 37 (locked member) of an approximate cylinder shape disposed on the upper side (the face on the cartridge 100 side) of the front end portion of the lever main body 47 to protrude. Between a bottom face 243 of the wall body 244 and the substrate 241, a gap is formed, and the lever member 45 is disposed by using the gap.

On the bottom face 243 of the wall body 244, a protruded portion 242 is disposed. The shaft hole 36 of the lever member 45 is inserted into the protruded portion 242. The lever member 45 is supported by the shaft in the state of being rotatable about the protruded portion 242. In other words, the protruded portion 242 serves as a rotation shaft of the lever member 45. In addition, the periphery of the protruded portion 242 is maintained by a cap 67 and a coil spring 60 housed in a groove of the cap. This spring 60 has a function for supporting the lever member 45 so as to be rotatable with respect to the substrate 241 and a function for stabilizing the movement of the lever member 45 by biasing the lever member 45 upward.

In addition, the device-side fixation structure 50, as shown in FIGS. 6A and 6B, includes a spring 44 that applies a biasing force to the lever main body 47 in the rotation direction (−R direction). One end of the spring 44 is locked in a locking portion 46 that is disposed in a position biased toward a direction different from a direction from the position of the shaft hole 36 of the lever main body 47 toward the locking pin 37. In addition, the other end of the spring 44 is locked in a locking portion 244b disposed on the lower face of the wall body 244. When a force against the biasing force of the spring 44 is applied to the lever member 45, the lever member 45 rotates in an arrow direction (+R direction) shown in FIGS. 6A and 6B.

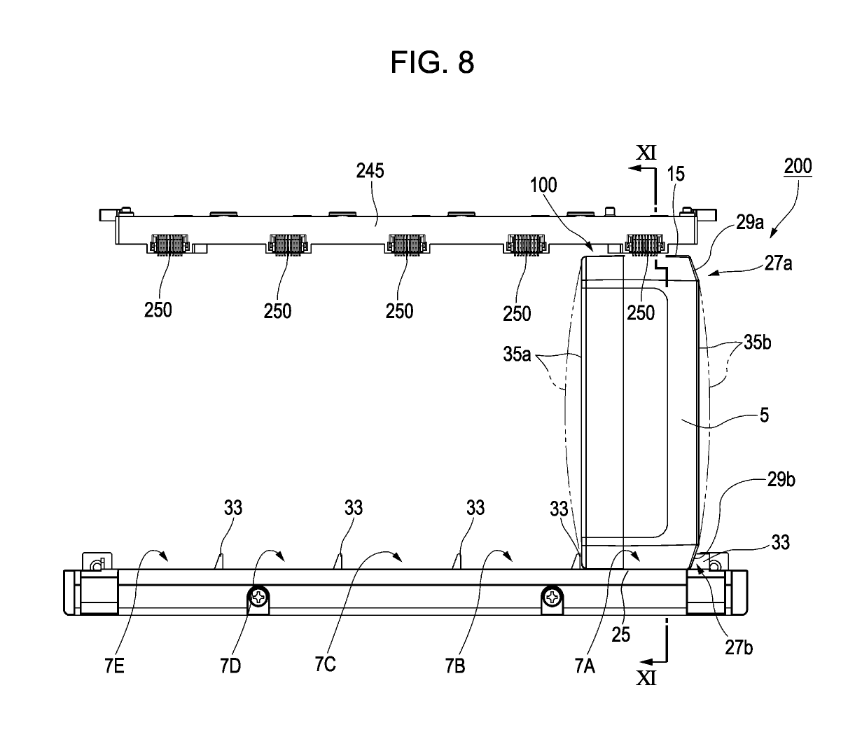

FIG. 7 is a front view of a container holder in which liquid housing containers are installed. FIG. 8 is a front view of a container holder from which some liquid housing containers are detached. The ink cartridge 100 according to this embodiment, as shown in FIGS. 7 and 8, is detachably attached to the cartridge slots 7A to 7E of the cartridge holder 200 of a commercial ink jet printing apparatus 211 (see FIG. 1) as a liquid ejecting apparatus and supplies ink to the print head 225 of the printing apparatus.

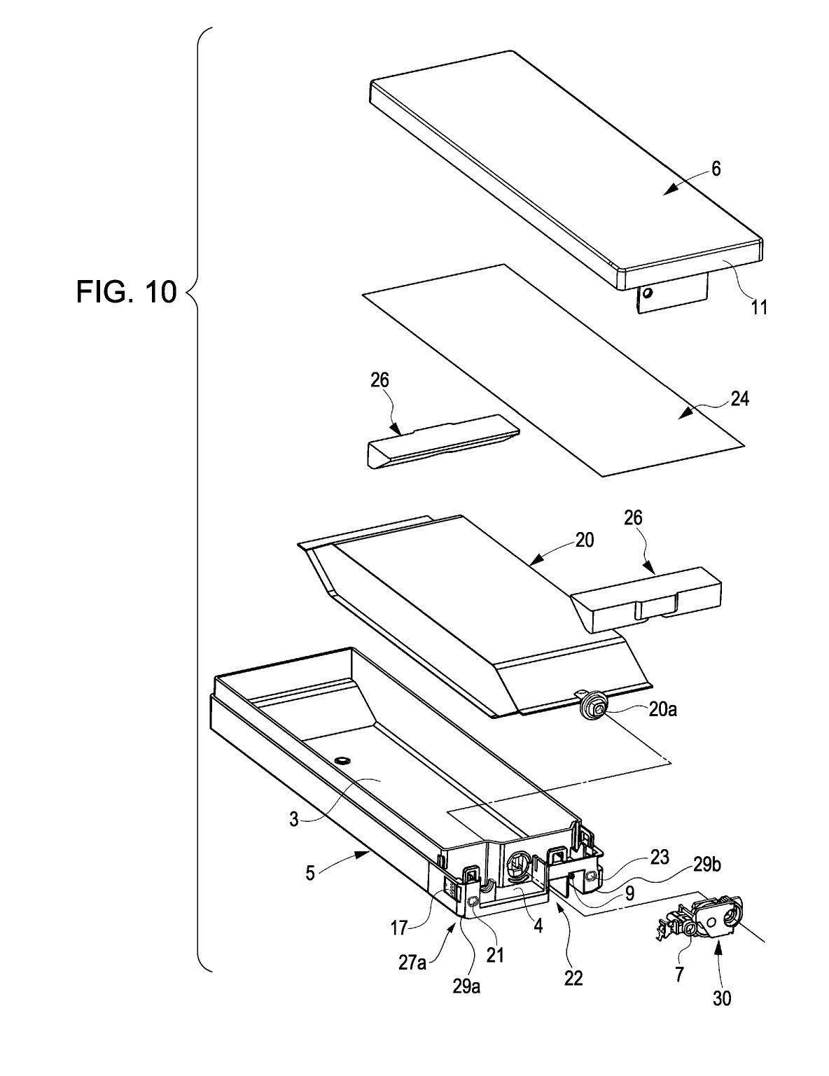

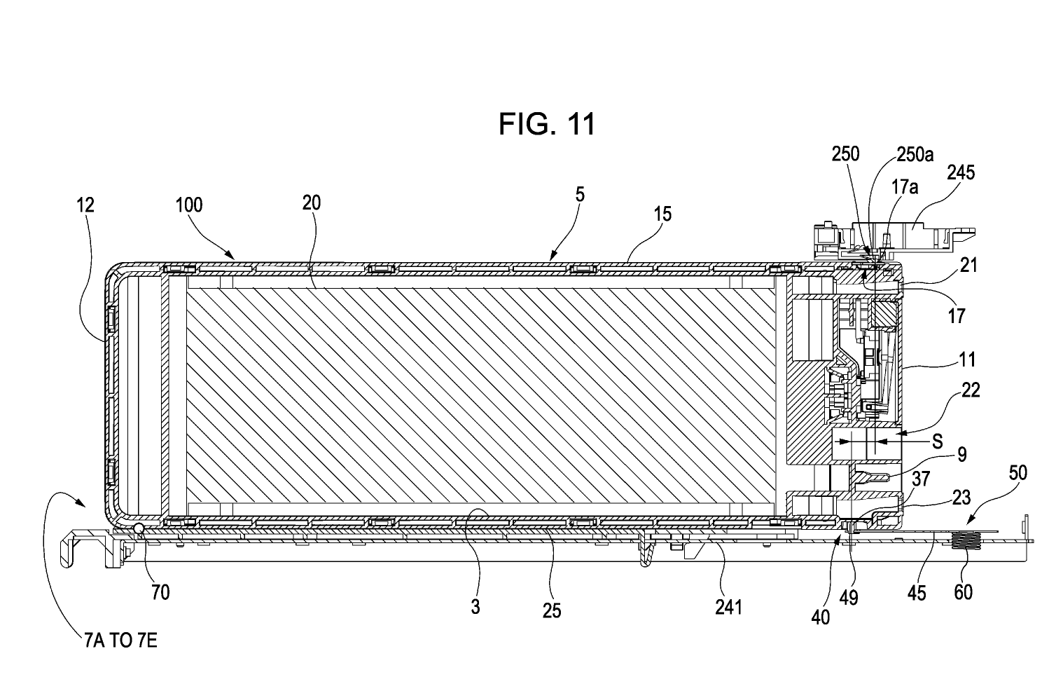

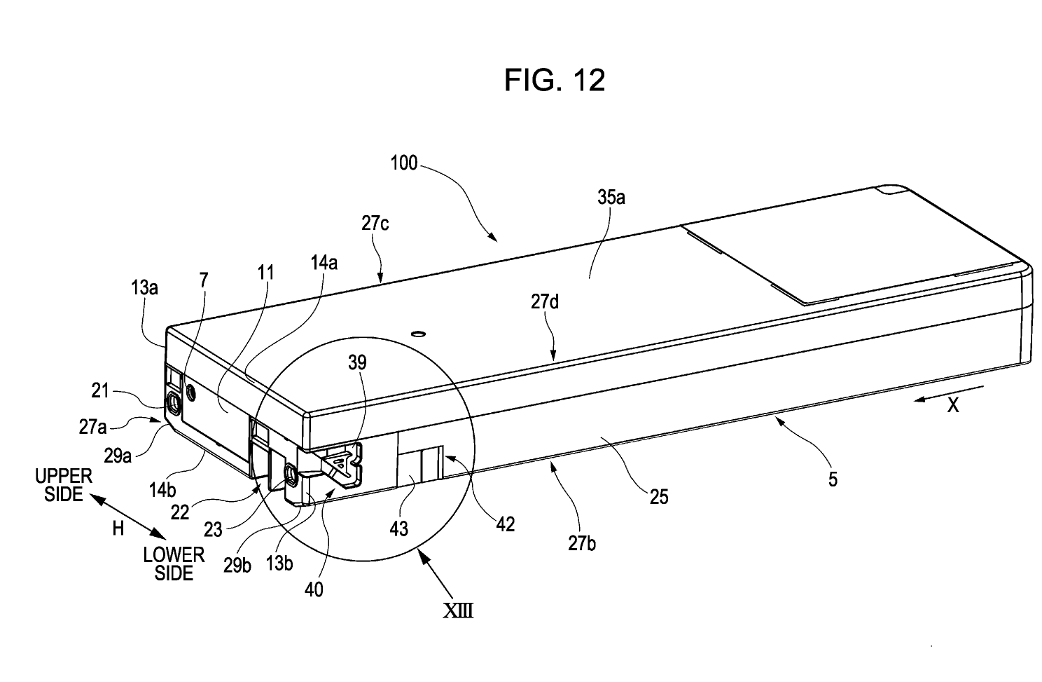

FIG. 9 is a perspective view of a liquid housing container, viewed from the side of one side face thereof. FIG. 10 is an exploded perspective view of the liquid housing container shown in FIG. 9. FIG. 11 is an arrow view taken along line XI-XI shown in FIG. 8. FIG. 12 is a perspective view of the liquid housing container, viewed from the side of the other side face.

The ink cartridge 100, as shown in FIG. 9, includes a flat case 5 having an approximately rectangular parallelepiped shape. Inside the case 5, as shown in FIG. 10, a pouch housing portion 3 is formed by being partitioned. In the pouch housing portion 3, an ink pack 20 as a liquid housing chamber is disposed. In addition, the ink cartridge 100 includes a liquid remaining amount detecting unit 30 and an ink supply opening 7 (liquid supply opening). The liquid remaining amount detecting unit 30 can be attached to or detached from the case 5. In addition, the ink supply opening 7 is disposed in the liquid remaining amount detecting unit 30.

The case 5 is a case that is formed by a resin molding process. The case 5 includes a pouch housing portion 3 having a box shape with an open top portion and a detection unit housing portion 4 that is disposed on the front face side of the pouch housing portion 3. In the pouch housing portion 3, the ink pack 20 and a spacer 26 made of resin are housed. The ink pack 20 is a flexible pouch body formed from an aluminum-laminate multi-layer film that is formed by forming an aluminum layer on a resin film layer for being laminated. The spacer 26 made of resin is disposed on front and rear inclination portions of the ink pack 20. In addition, in the detection unit housing portion 4, the liquid remaining amount detecting unit 30 is housed.

The opening face of the pouch housing portion 3 is sealed by a sheet film 24 after housing the ink pack 20 and the spacer 26 made of resin therein. A compression chamber is partitioned to be formed inside the case 5 by the pouch housing portion 3 and the sheet film 24.

Then, when the surface of the pouch housing portion 3 is covered with the sheet film 24 so as to allow the pouch housing portion 3 to become a sealing chamber, the spacer 26 prevents rattling of the ink pack 20 inside the sealing chamber and fills in a redundant empty space inside the sealing chamber, whereby increasing the compression efficiency for pressurizing the inside of the pouch housing portion 3 with the compression air.

On the sheet film 24 that seals the opening faces of the pouch housing portion 3 and the detection unit housing portion 4, a cover 6 made of resin is disposed.

In this embodiment, there are five types of the ink cartridges 100. Inside the ink pack 20 of the five types of ink cartridges 100, ink of five different colors is stored. The five types of the ink cartridges 100 are the same as described as the types of ink stored inside the ink packs 20 except for only a detailed shape of the identification portion 22, and other configurations are the same as those of the types of ink.

As shown in FIGS. 9 and 11, the ink cartridge 100 has an approximate rectangle-shaped front end face 11 and a rear end face 12 opposing thereto. The front end face 11 and the rear end face 12 are the faces of the ink cartridge 100 that become the front end and the rear end in the insertion direction when the ink cartridge 100 is installed to one of the cartridge slots 7A and 7E. As shown in FIGS. 7 to 9 and FIGS. 11 and 12, the ink cartridge 100 has a first side face 15 that intersects with a first shorter side 13a of the approximate rectangle-shaped front face 11, a second side face 25 that intersects with a second shorter side 13b of the approximate rectangle-shaped front face 11, a third side face 35a that intersects with a first longer side 14a of the approximate rectangle-shaped front face 11, and a fourth side face 35b that intersects with a second longer side 14b of the approximate rectangle-shaped front face 11.

As shown in FIGS. 7, 8, and 11, the ink cartridges 100 are installed to the cartridge slots 7A to 7E in the vertically arranged state.

The ink cartridges 100 are installed to the cartridge slots 7A to 7E such that the first side face 15 is positioned on the upper side and the second side face 25 is positioned on the lower side. In addition, a plurality of the ink cartridges 100 is aligned in parallel so as to be disposed on the substrate 241 in the state in which the third side face 35a and the fourth side face 35b face each other in a direction parallel to the vertical direction. As shown in FIG. 7, one of the support side walls 262, which forms one pair, of the cartridge holder 200 faces the third side face 35a of one ink cartridge of the ink cartridges 100 located on both outer ends. In addition, the other support side wall 262 faces the fourth side face 35a of the other ink cartridge of the ink cartridges 100 located on both outer ends.

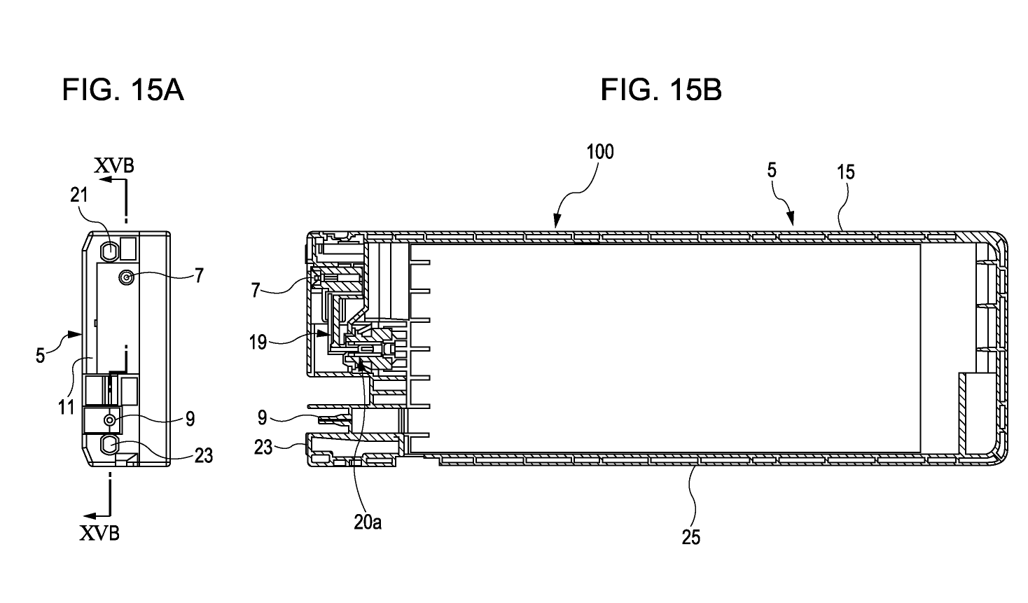

As shown in FIGS. 9 and 15, in the front end face 11, the ink supply opening 7 and an air inflow opening 9 are disposed. The ink supply opening 7 is connected to an ink ejection opening 20a of the ink pack 20 (see FIG. 10). The ink ejection opening 20a is located near the center of the front end face of the ink pack 20. In other words, in the state in which the ink cartridges 100 are installed to the cartridge slots 7A to 7E, the ink supply opening 7 is disposed to be deviated upward from the center of the ink pack in the height direction (vertical direction). In addition, between the ink supply path 7 and the ink ejection opening 20a, a flow path 19 connecting the ink supply path 7 and the ink ejection opening 20a is disposed.

When the ink cartridges 100 are not installed to the cartridge slots 7A to 7E, the ink supply opening 7 is sealed by a valve or a seal. At this time, pressure (static pressure) for allowing ink filled in the ink pack 20 to come out from the ink supply opening 7 is applied to the ink supply opening 7. The static pressure increases as the amount of ink stored inside the ink pack 20 is increases. Accordingly, the static pressure (initial static pressure) in the initial state in which ink is sufficiently filled in is high. When the ink supply opening 7 is opened in the state in which the static pressure inside the ink pack is relative high, there is a possibility that the ink comes out from the ink supply opening 7.

However, as in this embodiment, when the ink supply opening 7 is positioned to the upper side relative to the center of the ink pack 20 in the height direction (vertical direction), the static pressure of the ink inside the ink pack 20 is lowered in the position of the ink supply opening 7. Accordingly, the static pressure applied to the ink supply opening 7 can be lowered further due to an action of flow path resistance or the like that is caused by the flow path 19 connecting the ink supply opening 7 and the ink ejection opening 20a together. In other words, according to this embodiment, even in a case where the ink cartridges 100 are installed to the cartridge slots 7A to 7E, it is difficult for the ink to leak from the ink supply opening 7 when the ink supply pin 249 is inserted into the ink supply opening 7.

Here, with reference to FIGS. 1, 4, 5, 9 to 12, the supply of ink from the ink pack 20 to the print head 225 will be described.

When the ink cartridges 100 are installed to the cartridge slots 7A to 7E, the ink supply pin 249 described in advance is inserted into the ink supply opening 7. The ink supply pin 249 is connected to the print head 225 through the ink supply path 223 and the valve unit 224.

In addition, when the ink cartridge 100 is installed to the cartridge slots 7A to 7E, the air inflow opening 9 is inserted into the air communication opening 248 described in advance. The air communication opening 248 is connected to the compression pump 226 through the compression air supply path 227. As the compression pump 226 supplies pressurized air to the pouch housing portion 3 through the compression air supply path 227, the air communication opening 248, and the air inflow opening 9, the ink pack 20 can be pressurized. As the ink pack 20 is pressurized as described above, the ink flowing out from the ejection opening 20a of the ink pack 20 is supplied to the print head 225 of the ink the printing apparatus 211 through the ink supply opening 7.

As shown in FIGS. 9 and 12, in the front end face 11 of the ink cartridge 100, one pair of position determining holes 21 and 23 are disposed so as to be apart from each other. Hereinafter, the functions of the position determining holes 21 and 23 and the one pair of the position determining pins 247 and 247 described in advance will be described with reference to FIGS. 4, 5, 9, and 11.

When the ink cartridges 100 are inserted into the cartridge slots 7A to 7E, the front ends of the position determining pins 247 and 247 are fitted into the position determining holes 21 and 23. Thereafter, as the ink cartridges 100 are inserted further to the rear side of the cartridge slots 7A to 7E, the ink cartridge 100 moves with the position determining pin 247 used as a reference.

When the ink cartridges 100 are completely installed to the cartridge slots 7A to 7E, the position determining holes 21 and 23 are fitted into the one pair of position determining pins 247 and 247, whereby the position of the ink cartridge 100 in the direction along the front end face 11 can be determined. Accordingly, the movement of the cartridge 100 in the direction along the front end face 11 is regulated.

As shown in FIG. 11, the one pair of the position determining holes 21 and 23 and the circuit substrate 17 and a container-side fixation structure 40, which will be described later, are arranged on an approximately same longitudinal cross-section XI-XI (see FIG. 8).

As shown in FIG. 9, on the first side face 15 of the ink cartridge 100, the circuit substrate 17 is disposed. The circuit substrate 17 is disposed in a position near the front end face 11 relative to the rear end face 12, in particular, in a position adjacent to the front face end 11. On the circuit substrate 17, a memory element, not shown in the figure, for recording information such as a remaining amount of ink or the use history of the cartridge is mounted.

In addition, in the liquid remaining amount detecting unit 30, a remaining amount detecting sensor (sensor using a piezoelectric element), not shown in the figure, is disposed. The remaining amount detecting sensor is a sensor that is used for detecting the remaining amount of ink inside the ink cartridge. On the circuit substrate 17, at least one electrode that is electrically connected to the remaining amount detecting sensor is disposed.

On the other hand, as shown in FIG. 11, above the circuit substrate 17, a device-side terminal 250 is disposed. When the ink cartridges 100 are installed to the cartridge slots 7A to 7E (see FIGS. 3, 7, and 8), the contact point 17a of the electrode of the circuit substrate 17, as described above, is brought into contact with a contact point 250a of the device-side terminal 250 (see FIGS. 3, 7, and 8). Accordingly, the electrode and the device-side terminal 250 are electrically connected to each other.

When the contact point 17a of the electrode of the circuit substrate 17 is brought into contact with the contact point 250a of the device-side terminal 250 of the container installation portion 1 by installing the ink cartridge 100 in the cartridge holder 200 of the printing apparatus 211 (see FIG. 1), the memory element and the remaining amount detecting sensor 211 (see FIG. 1) are electrically connected to a control circuit on the printing apparatus 211 (see FIG. 1) side through the circuit substrate 17. Accordingly, it is possible to control the operations of the memory element and the remaining amount detecting sensor from the printing apparatus 211 (see FIG. 1) side.

As shown in FIGS. 7 to 9 and FIG. 12, a corner portion 27a corresponding to a side on which the first side face 15 and the fourth side face 35b of the ink cartridge 100 intersect with each other and a corner portion 27b corresponding to a side on which the second side face 25 and the fourth side face 35b intersect with each other have a shape notched along the insertion direction (the direction of arrow X shown in FIG. 12) of the ink cartridge 100, respectively. In other words, in the corner portions 27a and 27b, one pair of C faces 29a and 29b are disposed. In addition, as shown in FIGS. 2 to 5 and FIGS. 7 and 8, a wall partitioning the cartridge 100 is not disposed inside the cartridge holder 200.

Accordingly, as shown in FIG. 7, when the ink cartridges 100 each having an approximately flat rectangular parallelepiped shape are vertically arranged, in other words, when the ink cartridges are housed to be aligned in parallel in the state in which the first side face 15 is located upward and the second side face is located downward, the ink cartridges 100 are arranged in parallel such that the third side face 35a and the fourth side face 35b of the adjacent ink cartridges 100 are disposed to face each other. In addition, on C faces 29a and 29b of one ink cartridge 100 of adjacent ink cartridges 100, spaces 31a and 31b having a triangular cross-section are formed to extend in the insertion direction of the ink cartridge 100.

On the other hand, in the cartridge holder 200, as shown in FIGS. 2, 5, 6, and 7, a guide rail 33 that is a guide protrusion having a triangular cross-section corresponding to a notched shape (the space 31) of the corner portion 27 in which the C face 29 is formed is disposed along the insertion direction of the ink cartridge 100.

In addition, as shown in FIG. 7, a guide protrusion 265 having a triangular cross-section corresponding to the upper space 31a that is formed by the upper C face 29a is disposed on the front side of the surfaces of the cartridge slots 7A to 7E. Accordingly, the lower space 31b of the triangular cross-section shaped spaces 31a and 31b becomes a space for installation of the guide tail 33, and the upper space 31a becomes a space for installation of the guide protrusion 265.

In addition, as shown in FIGS. 3 and 4, a guide protrusion 265 having a triangle-shaped cross-section corresponding to the upper space 31a that is formed by the upper C face 29a is disposed to protrude, at least near the attachment and detachment opening of the cartridge slots 7A to 7E. The guide protrusion 265 is disposed on the top portion so as to face the guide rail 33 disposed on the substrate 241. Accordingly, the lower space 31b of the spaces 31a and 31b each having a triangle-shaped cross-section becomes a space for installation of the guide rail 33, and the upper space 31a become a space for installation of the guide protrusion 265.

In the structure in which the guide rail 33 having a triangle-shaped cross-section corresponding to the C face 29b is disposed along the insertion direction of the ink cartridge 100, in a case where a plurality of the ink cartridges 100 each having an approximately flat rectangular parallelepiped shape is vertically arranged in parallel so as to be housed in the cartridge holder 200, the guide rail 33 having a cross-section of a substantially same triangle shape can be disposed in the insertion direction of the ink cartridge 100 in the space 31b having a triangle-shaped cross-section that is formed on the lower portion between adjacent ink cartridges 100.

Each ink cartridge 100 is guided and positioned in the insertion direction inside the cartridge holder 200 by the guide rail 33. Accordingly, partition walls that partition the cartridge slots 7A, 7B, 7C, 7D, and 7E of the cartridge holder 200 are not needed between the adjacent ink cartridges 100.

When the ink pack 20 is pressurized from the outside by introducing compression air into the pouch housing portion 3 for supplying ink to the ink jet printing apparatus 211, as shown in FIG. 8, as denoted by imaginary lines, one pair of maximum faces (the third and fourth side faces) 35a and 35b, which are parallel to each other, of the case 5 of each ink cartridge 100 is mainly dilated so as to be deformed. The amount of dilation deformation changes based on various conditions such as the size of the cartridge 100, the material of the case 5, and the pressure of the compression air introduced into the pouch housing portion 3. For example, when the pressure of the compression air is 12 to 18 kPa, the amount of dilation deformation on one side may be a maximum of about 5 to 10 mm.

In this embodiment, a partition wall is not disposed inside the cartridge holder 200. Thus, when the compression air is introduced into the pouch housing portion 3, the maximum faces 35a and 35b of adjacent cases 5 dilate to be deformed. Inside the cartridge slots 7A to 7E in which any partition wall is not disposed, at least parts of the maximum faces 35a and 35b of the adjacent ink cartridges 100 are brought into contact with each other so as to press each other. In addition, of the maximum faces 35a and 35b of the ink cartridges 100 located on both outer ends, as shown in FIG. 7, at least parts of the maximum faces 35a and 35b, which do not face the maximum faces 35b and 35a of another container, are brought into contact with the support side wall 262 of casings 260 facing each other so as to press each other.

In other words, as shown in FIG. 7, when pressurized fluid is introduced into each ink cartridge 100 installed to the cartridge slots 7A to 7E, the cartridges 100 are a locking state between one pair of support side walls 262 and 262 of the cartridges 100 due to dilation forces thereof. Then, a plurality of ink cartridges 100 of which dilation deformation is regulated is fixed to the cartridge slots 7A to 7E, strongly and integrally.

Then, when the pressurizing of the compression chamber is released, and dilating ink cartridges 100 are returned to the original shapes thereof, the pressurized contact between the adjacent ink cartridges 100 or between the cartridge 100 and the support side wall 262 disappears, whereby attachment or detachment of the ink cartridges 100 can be performed smoothly.

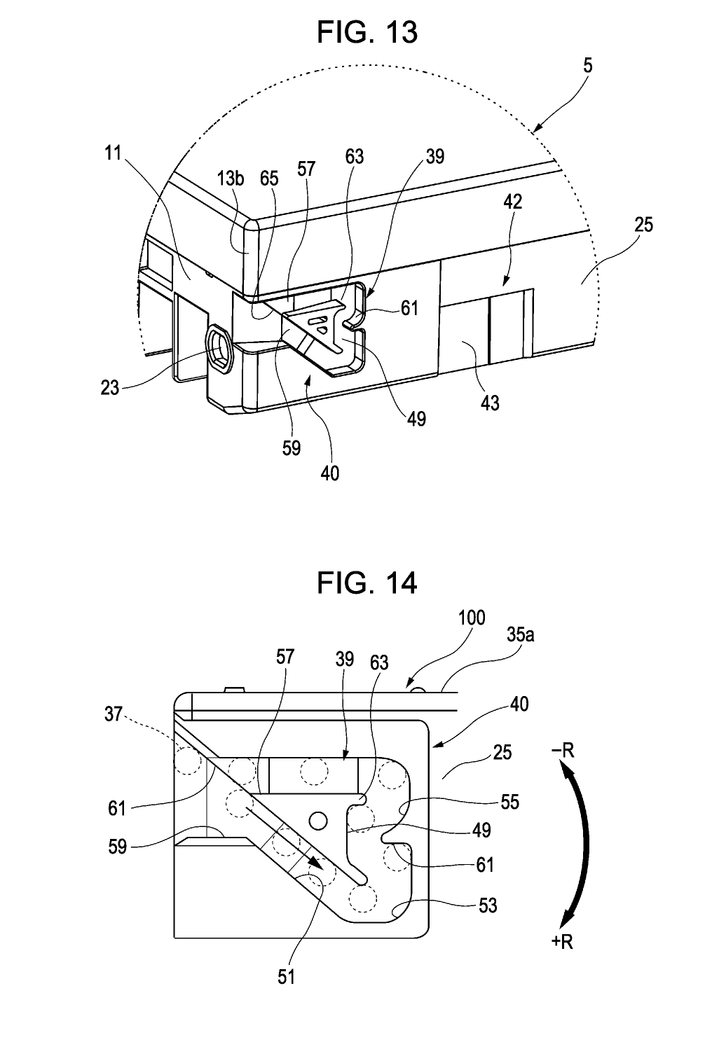

FIG. 13 is an enlarged diagram of portion XIII shown in FIG. 12. FIG. 14 is an enlarged plan view of the guide groove shown in FIG. 13.

As shown in FIGS. 12 and 13, on the second side face 25, in the state in which the ink cartridges 100 are installed to the cartridge slots 7A to 7E against the biasing force in a direction opposite to the insertion direction, the container-side fixation structure 40, which regulates the ink cartridges 100 such that the movement of the ink cartridges 100 in the direction opposite to the insertion direction can be released in cooperation with the device-side fixation structure 50 installed to the cartridge slots 7A and 7E, is disposed. The device-side fixation structure 40 is disposed in a position near the front end face 11 relative to the rear end face 12, in particular, in a position adjacent to the front end face 11. In addition, in a position on the second side face 25 far from the front end face 11 relative to the container-side fixation structure 40, a concaved portion 43 is disposed. The concaved portion 43 is not located to be adjacent to the front end face but is disposed in a position near the front end face 11 relative to the rear end face 12.

The container-side fixation structure 40, as shown in FIG. 13, includes a guide groove 39 in which the locking pin 37 of the device-side fixation structure 50 (see FIG. 3) is inserted and guides the locking pin 37 as a locked member to a locking position or a non-locking position at a time when attachment of detachment of the ink cartridges 100 to or from the cartridge slots 7A to 7E is performed. In addition, the container-side fixation structure 40 includes a locking portion, in which the locking pin 37 is locked, regulating the movement of the ink cartridge 100 in the pullout direction in the state in which the ink cartridges 100 are installed to the cartridge slots 7A to 7E.

As shown in FIG. 14, the guide groove 39 includes: an entrance guide portion 51 that guides the locking pin 37 when the ink cartridges 100 are inserted into the cartridge slots 7A to 7E; an intermediate guide portion 53 that leads the locking pin 37 to the locking portion 49 when the ink cartridges 100 inserted into the cartridge slots 7A to 7E are pushed back in the pullout direction; and an exit guide portion 55 that guides the locking pin 37 deviated from the locking portion 49 to an exit of the guide groove 39 by pushing the ink cartridges 100 in the insertion direction when the ink cartridges 100 are detached from the cartridge slots 7A to 7E.

An exit portion 57 of the guide groove 39 is connected to an entrance portion 59, and accordingly, the guide groove 39 forms a loop as a whole. In a connection portion between the entrance portion 59 and the exit portion 57, the depth of the groove of the exit portion 57 is less than that of the entrance portion 59, and accordingly, a level difference 65 is formed in the connection portion. The level difference 65 prevents entrance of the locking pin 37 into the exit portion 57 when the ink cartridges 100 are inserted into the cartridge slots 7A to 7E.

As shown in FIG. 12, below the container-side fixation structure 40, the device-side fixation structure 50 is disposed. The device-side fixation structure 50, as described above, includes the lever member 45 and the spring 44 shown in FIG. 6B.

The lever member 45 is biased in a constant rotation direction by the spring 44. This direction is the direction of a −R direction of an arrow shown in FIG. 6B, and is the counterclockwise direction in FIG. 13. When the ink cartridges 100 are attached to or detached from the cartridge slots 7A to 7E, the locking pin 37 is inserted into the guide groove 39 so as to be guided. Thus, the lever member 45 rotates in ±R directions in accordance with the shape of the guide groove 39.

The locking pin 37 disposed in the front end portion of the lever member 45, as shown in FIG. 11, is disposed in a direction intersecting with the second side face 25 of the ink cartridge 100. When the locking pin 37 is inserted into the guide groove 39, the locking pin 37 presses the bottom face of the guide groove 39 upward in accordance with an elastic force of the lever main body 47 configuring the lever member 45.

Next, the operation of the locking pin 37 within the guide groove 39 at the time of the operation of attachment or detachment of the ink cartridge 100 will be described with reference to mainly FIG. 14.

When the ink cartridges 100 are inserted into the cartridge slots 7A to 7E and the ink cartridges 100 are pushed further in the insertion direction against the biasing force of the slider member 246 (see FIGS. 4 and 5), the locking pin 37 is inserted into the entrance portion 59 of the guide groove 39.

The locking pin 37 is biased toward the side of the bottom face of the guide groove 39 by elastically deforming the lever main body 47 (see FIGS. 6A to 6C) of the lever member 45 (see FIGS. 6A to 6C). When passing through a terminal portion of the entrance guide portion 51, the locking pin 37 moves in the counterclockwise direction shown in FIG. 14 by the biasing force of the spring 44 (see FIGS. 6A to 6C).

Then, the locking pin 37 collides with a side wall portion 61 for temporary stop and stops. At this time, a click sound is generated. A user can check that the ink cartridge 100 is inserted with sufficient depth by the click sound.

Next, when the pressing for the ink cartridge in the insertion direction is released by the user, the ink cartridge 100 is pushed back a little by the biasing force of the slider member 246 (see FIGS. 4 and 5). Accordingly, the engagement of the locking pin 37 on the side wall portion 61 for temporary stop is released. Thus, the locking pin 37 moves in the counterclockwise direction by the biasing force of the spring 44.

Then, the locking pin 37 collides with a side wall portion 63 for final stop that is disposed in the locking portion 49 and stops at the locking position. At this time, a click sound is generated. The user can check that the ink cartridges 100 are fixed to the cartridge slots 7A to 7E (see FIGS. 2, 4, 5, 7, and 8) by the click sound. In addition, even in the state in which the ink cartridges 100 are installed to the cartridge slots 7A to 7E, the locking pin 37 presses the bottom face of the guide groove 39 by the elastic force of the lever main body 47.

Then, at the time of detachment of the cartridges, by pushing the ink cartridge 100 that is in the locked state, the engagement of the locking pin 37 with the side wall portion 63 for final stop is released. Accordingly, the locking pin 37 relatively moves to a non-locking position along the exit guide portion 55 by the biasing force applied to the lever member 45 by the spring 44. Then, the cartridge 100 is pushed back by the biasing force of the slider member 246 (see FIG. 3). The locking pin 37 moves towards the exit portion 57 in accordance with movement of the cartridge 100 at this time. Finally, the locking pin 37 is dropped out of the exit portion 57, and the ink cartridges 100 can be detached from the cartridge slots 7A to 7E.

As shown in FIGS. 12 and 13, the concaved portion 43 is disposed on the second side face 25 of the ink cartridge 100. However, a particular function is not implemented in the concaved portion 43.

Next, the positional relationship between the device-side terminal 250 and the locking pin 37 in a state in which the ink cartridge 100 is installed, that is, a state in which the locking pin 37 is locked in the locking portion 49 will be described with reference to mainly FIG. 11.

The device-side terminal 250 includes a contact point 250a that is brought into contact with the contact point 17a of the electrode of the circuit substrate 17 that is installed to the first side face 15 of the ink cartridge 100. The contact point 250a is brought into contact with the contact point 17a in a position closer to the front end face of the ink cartridge 11 than to the position of the locking pin 37 locked in the locking portion 49 by a distance S.

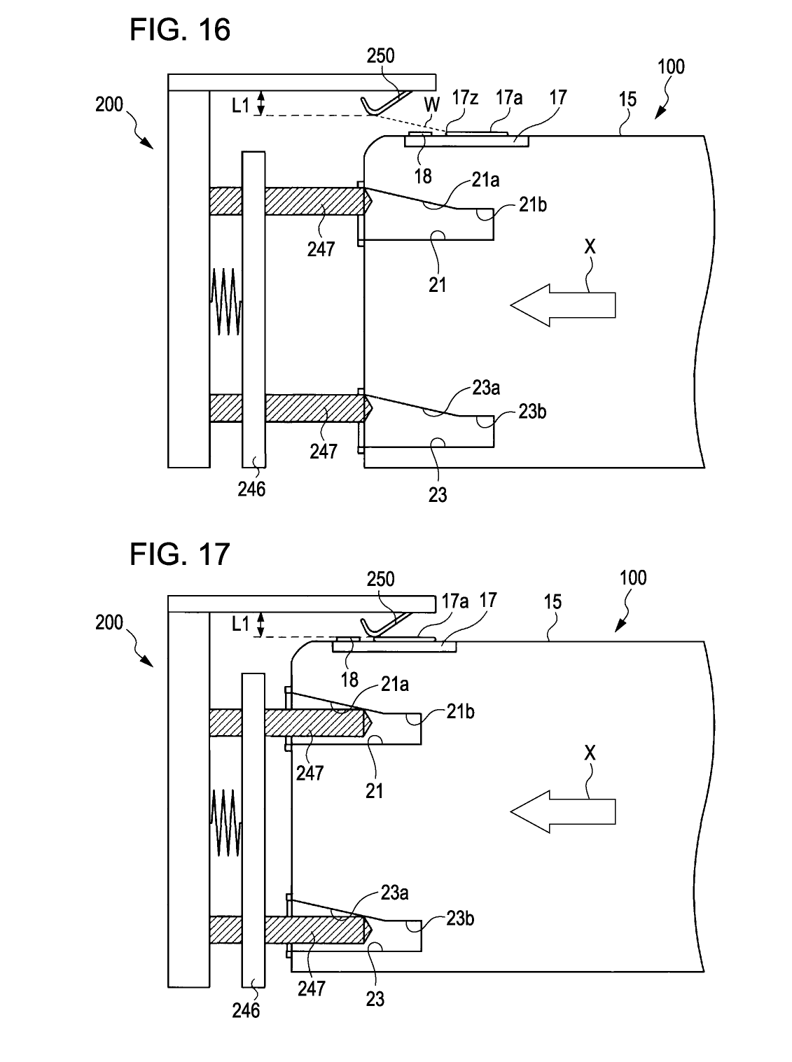

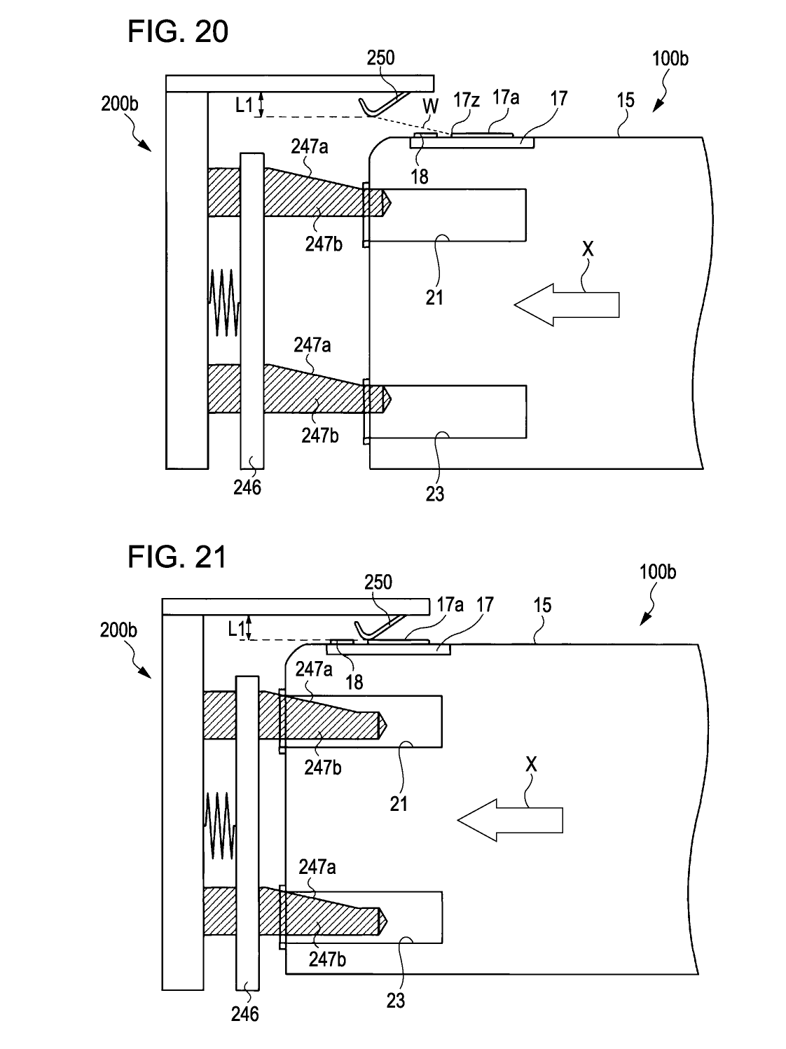

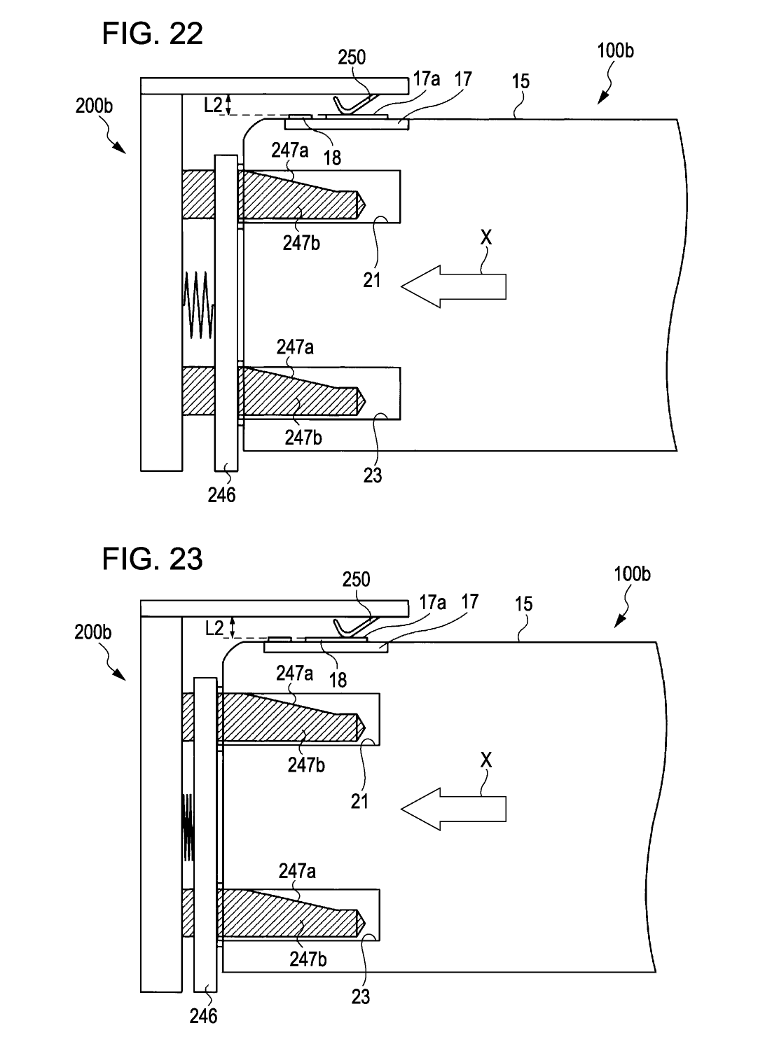

FIGS. 16 to 19 are explanatory diagrams schematically illustrating a procedure of inserting the ink cartridge 100 into the cartridge holder 200. In addition, in FIGS. 16 to 19, mechanisms such as the ink supply opening 7 and the air inflow opening 9 are omitted, which applies the same in FIGS. 20 to 24 described below. In the cartridge holder 200, as described above, the position determining pin 247 and the device-side terminal 250 are disposed. In the ink cartridge 100, the position determining holes 21 and 23 and the circuit substrate 17 are disposed. The circuit substrate 17 has a face that is approximately parallel to the insertion direction X of the ink cartridge 100, and the contact point 17a is disposed on the circuit substrate 17. Here, the contact point 17a is also referred to as a “terminal 17a”. The circuit substrate 17 is fixed to the surface 15 (the first side face 15) of the ink cartridge 100 by a cocking pin 18. In the position determining holes 21 and 22, inclination portions 21a and 23a that are disposed to be inclined with respect to the insertion direction X of the ink cartridge 100 are formed. The terminals 250 and 17a are formed from conductive member (commonly, metal). Thus, the cocking pin 18 and the surface 15 of the ink cartridge 100 are formed from a non-conductive member (commonly, non-conductive plastic).

When the user inserts the ink cartridge 100 in the insertion direction X, the ink cartridge 100 moves along the inclination portions 21a and 23a (see FIGS. 16 to 19). Here, a broken line shown in FIG. 16 is the trajectory W of an end portion 17z of the contact point 17a when a user inserts the ink cartridge 100 into the cartridge holder 200. The trajectory W is parallel to the inclination faces 21a and 23a. As described above, it is preferable that the inclination portions 21a and 23a are formed such that the device-side terminal 250 is brought into contact first with the terminal 17a without being in contact with the surface 15 of the ink cartridge 100 or the cocking pin 18. In such a case, generation of grinding powders due to grinding of the surface 15 of the ink cartridge 100 or the cocking pin 18 can be prevented. Accordingly, generation of defective contact due to pinching grinding powers between the device-side terminal 250 and the terminal 17a can be prevented. In addition, generation of deformation of the device-side terminal 250 not originally designed or generation of damages in the circuit substrate 17 due to contact of the device-side terminal 250 with a member (for example, the circuit substrate 17 or the like) other than the terminal 17a can be suppressed.

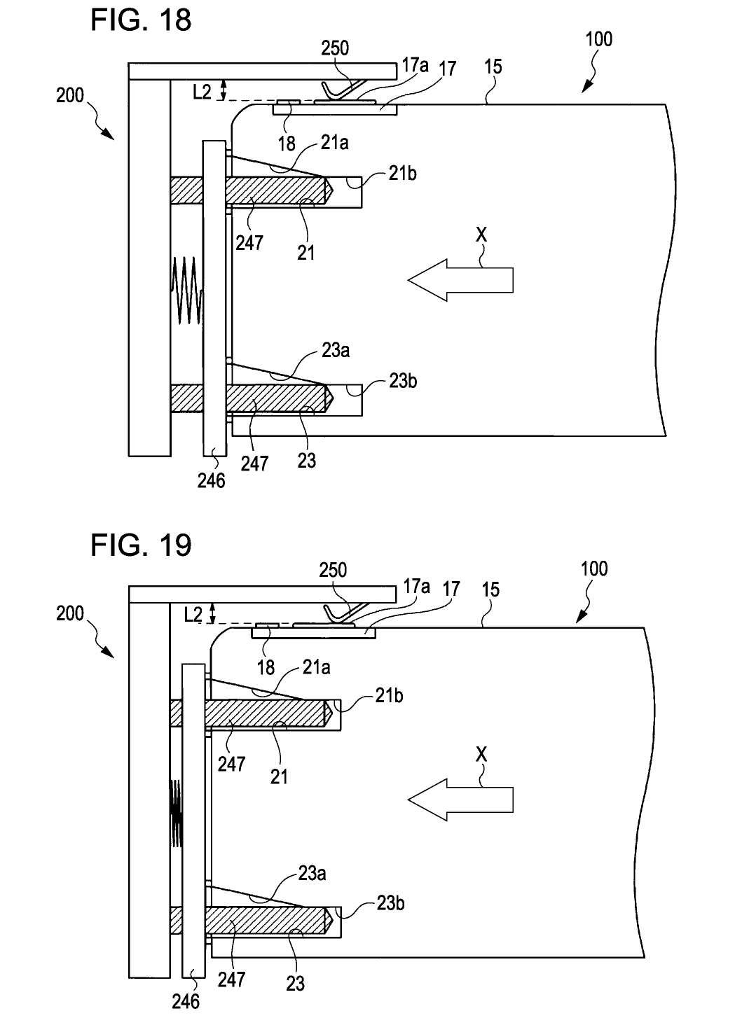

FIG. 17 is a schematic diagram showing the state at the moment when the device-side terminal 250 and the terminal 17a are brought into contact with each other. FIG. 18 is a schematic diagram showing a state in which the ink cartridge 100 is inserted into the cartridge holder 200 further from the state shown in FIG. 17. As shown in FIG. 17, the front end portion of the position determining pin 247 is in contact with the inclination portions 21a and 23a even at the moment when the device-side terminal 250 and the terminal 17a are brought into contact with each other. Accordingly, when the user inserts the ink cartridge 100 from this state (FIG. 18), the device-side terminal 250 is pushed upward by the terminal 17a. In other words, the amount of protrusion of the device-side terminal 250 decreases from L1 to L2 (FIGS. 16 to 18). Accordingly, the device-side terminal 250 and the terminal 17a are brought into contact with each other assuredly by a repulsive force of the device-side terminal 250, whereby generation of defective contact between terminals can be suppressed further. FIG. 19 is a schematic diagram showing a state in which the ink cartridge 100 is fixed to the cartridge holder 200. In this state, the position determining pin 247 is inserted into the inner sides of the position determining holes 21 and 23 so as to reach flat portions 21b and 23b, whereby the ink cartridge 100 is fixed.

In addition, in the process for inserting the ink cartridge 100, it is preferable that the position determining pin 247 and position determining hole 21 are configured such that the device-side terminal 250 and terminal 17a starts to be in contact with each other after ink can be supplied by inserting the ink supply pin 249 into the ink supply opening 7. The reason is for preventing the ink jet printing apparatus 211 from incorrectly recognizing that the ink cartridge 100 is installed in a predetermined position due to communication that can be made between the ink jet printing apparatus 211 and the ink cartridge 100 in spite of the state in which the ink supply pin 249 is not sufficiently inserted into the ink supply opening 7 and ink cannot be supplied. Similarly, it is preferable that the position determining pin 247 and the position determining hole 21 are configured such that the device-side terminal 250 and the terminal 17a start to be in contact with each other after the air inflow opening 9 and the air communication opening 248 are connected together.

In addition, as shown in FIGS. 16 and 17, the device-side terminal 250 is brought into contact first with the terminal 17a. Alternatively, the device-side terminal 250 may be configured to be brought into contact first with a portion other than the terminal 17a of the surface 15 of the ink cartridge 100. Also in such a case, when the surface 15 of the ink cartridge 100 is configured to approach and be in contact with the device-side terminal 250 in the direction of the inclination of the inclination portions 21a and 23a, the sliding distance of the device-side terminal 250 is shortened even in the configuration in which the device-side terminal 250 is configured to be in contact with the surface 15 of the ink cartridge 100 or the cocking pin 18. Accordingly, generation of the grinding powers can be suppressed, whereby generation of defective contact between terminals can be suppressed. In addition, since the device-side terminal 250 starts to be in contact with the surface 15 of the ink cartridge 100 in the direction of the inclination, generation of deformation not originally designed in the device-side terminal 250 can be suppressed.

As described above, according to this embodiment, as shown in FIGS. 16 to 19, when the inclination portions 21a and 23a of the position determining holes 21 and 23 are configured such that the device-side terminal 250 is brought into contact first not with the surface 15 of the ink cartridge 100 or the cocking pin 18 but with the terminal 17a when the ink cartridge 100 is inserted into the cartridge holder 200. Accordingly, it can be prevented that the surface 15 of the ink cartridge 100 or the cocking pin 18 is grinded and the grinding powers generate defective contact between the device-side terminal 250 and the terminal 17a.

In addition, according to this embodiment, as shown in FIG. 7, when the ink cartridges 100 are installed to the cartridge slots 7A to 7E, the space 31b is formed by the C face 29 between adjacent cartridges 100. In addition, the guide protrusion 33 is disposed in the space 31b.

Each cartridge 100 is guided by the guide protrusion 33 in the insertion direction and is positioned in the cartridge slots 7A to 7E. In other words, between the cartridges 100, any partition wall that partitions the cartridge slots 7A to 7E is not disposed.

Accordingly, a plurality of the ink cartridges 100 does not need to be separately arranged to be apart by a distance corresponding to the partition wall or the guide protrusion 33. In other words, the plurality of ink cartridges 100 can be housed with being closely positioned (high density). Accordingly, a compact cartridge holder 200 of which a total size of the housing width in the thickness direction of the container is small can be formed. In addition, the entire ink jet printing apparatus 211 can be produced in a compact size.

In addition, according to this embodiment, as described above, when the ink cartridge 100 is pressurized, the dilation deformation of each container is regulated. Accordingly, a difference between the device-side terminal 250 and the contact point 17a of the circuit substrate 17 can be prevented, whereby degradation of the electric connection can be prevented. In addition, a load, which will be described later, applied to the device-side fixation structure 50 and the container-side fixation structure 40 can be decreased, In addition, a plurality of the ink cartridges 100 are fixed to the cartridge slots 7A to 7E strongly and integrally by the dilation forces of the ink cartridges. Accordingly, any partition partitioning the cartridge slots 7A to 7E does not need to be disposed in the holder 200, and the holder 200 can be simplified and miniaturized.

In addition, the contact point 17a of the electrode of the circuit substrate 17 and the container-side fixation structure 40 are disposed on the first side face 15 and the second side face 25 of the ink cartridge 100. Accordingly, disposition of the device-side terminal 250 or the device-side fixation structure 50 between the third side faces 35a or the fourth side faces 35b of adjacent cartridges 100 is unnecessary. Therefore, the plurality of ink cartridges 100 can be housed with high density.

In other words, according to this embodiment, the plurality of the ink cartridges 100 can be housed with high density without decreasing the electrical connectivity between the device-side terminal 250 and the contact point 17a of the circuit substrate 17.

In addition, as shown in FIGS. 2 and 5, in this embodiment, the guide rails 33 are disposed on the substrate 241 on which a plurality of the third side faces 35a or fourth side faces 35b of the ink cartridge 100 are disposed in parallel to face each other in a direction parallel to the vertical face.

Accordingly, when the ink cartridges 100 are installed to the cartridge slots 7A and 7E, the guide protrusion 33 is disposed in the lower portion between the adjacent ink cartridges 100.

In other words, when the ink cartridges 100 are attached to or detached from the cartridge slots 7A to 7E, the lower portion of each cartridge 100 is guided. Accordingly, attachment of detachment of the cartridge 100 can be performed in an easy manner. In addition, the positions of the cartridges 100 can be determined more accurately within the cartridge slots 7A to 7E.

In addition, as shown in FIGS. 3, 4, and 7, in this embodiment, the guide protrusions 265 are disposed so as to face the guide rails 33. Accordingly, when the ink cartridge 100 is attached or detached, not only the lower face side of the ink cartridge 100 is guided by the guide rail 33 but also the surface side is guided by the guide protrusion 265. Therefore, attachment or detachment of the ink cartridge 100 can be performed in an easier manner.

In addition, the shape of the cross-section of the guide rail 33 or the guide protrusion 265 (see FIG. 4) is not limited to a triangle shape. Thus, various shapes can be used, as long as the ink cartridge 100 can be inserted therein. In addition, the shape of the C face can be appropriately changed in accordance with the shape of the cross section of the guide rail 33 or the guide protrusion 265.

Furthermore, the guide protrusion 265 (see FIG. 4) may be omitted. In such a case, the C face 29a corresponding to the guide protrusion 265 may be omitted. In addition, in accordance with the shape of the position of the guide protrusion 265 (see FIG. 4) or the guide rail 33, the C faces 29a or 29b can be disposed in the corner portion 27c (see FIGS. 9 and 12) corresponding to the side on which the third side face 35a and the first side face 15 intersect with each other or in the corner portion 27d (see FIGS. 9 and 12) corresponding to the side on which the third side face 35a and the second side face 25 intersect with each other. In other words, it is preferable that the C face is disposed in at least one of four corner portions 27a to 27d corresponding to two of the first to the fourth side faces 15, 25, 35a, and 35b intersect with each other.

In addition, as shown in FIG. 10, in this embodiment, the compression chamber of the ink cartridge 100 is partitioned to be formed by the pouch housing portion 3 having an open face as one face and the sheet film 24 that seals the open face. Accordingly, the sealing structure of the pouch housing portion 3 and the ink pack 20 can be configured in an easy manner, whereby the manufacturing costs can be reduced.

In this embodiment, as shown in FIG. 11, one pair of the position determining holes 21 and 23, the circuit substrate 17, a container-side fixation structure 40 are arranged on an approximately same longitudinal cross-section XI-XI (see FIG. 8). Accordingly, when the ink cartridges 100 are inserted into the cartridge slots 7A and 7E, and a pair of the position determining pins 247 and 247 are fitted into one pair of the position determining holes 21 and 23, the position of the cartridge 100 is determined in a direction along the front end face 11 (that is, a direction parallel to the longitudinal cross-sectional face). Accordingly, the positions of the contact point 17a of the circuit substrate 17 and the contact point 250a of the device-side terminal 250 that are located on one side of the longitudinal cross-section and the positions of the container-side fixation structure 40 and the device-side fixation structure 50 that are located on the other side are determined with high accuracy in the approach direction or in the separation direction.

In addition, in this embodiment, as shown in FIG. 7, the ink cartridges 100 having an approximately flat rectangular parallelepiped shape are aligned vertically to be in parallel. However, the ink cartridges 100 may be aligned vertically so as to be overlapped with one another. In other words, the third side face 35a or the fourth side face 35b of the ink cartridge 100 may be disposed to face in a direction perpendicular to the vertical face.

However, as in this embodiment, a configuration in which the ink cartridges are vertically aligned to be parallel, in particular, a configuration in which the first side face 15 on which the circuit substrate 17 is disposed and the device-side terminal 250 are disposed on the upper side and the second side face 25 on which the container-side fixation structure 40 is disposed and the device-side fixation structure 50 are disposed on the lower side is advantageous in that it can prevent occurrence of an electrical defect in the circuit substrate 17 due to leakage of ink in a case where the ink leaks between the ink supply opening 7 and the ink supply pin 249.

In addition, in this embodiment, all of the circuit substrate 17, the position determining hole 21, and the ink supply opening 7 are integrated on the upper side. As described above, by closely arranging these, the accuracy of the positions of the circuit substrate 17 and the device-side terminal 250 and the accuracy of the positions of the ink supply opening 7 and the ink supply pin 249 can be increased. In addition, since the ink supply opening 7 is disposed on the upper side, the ejection opening 20a of the ink pack 20 can be disposed on the relatively lower side, and accordingly, the initial static voltage can be decreased. In other words, as in this embodiment, when the first side face 15 is disposed to be the upper side, and the second side face 25 is disposed to be the lower side, a configuration in which the initial static voltage can be decreased with the accuracy of the positions of the circuit substrate 17 and the device-side terminal 250 and the accuracy of the positions of the ink supply opening 7 and the ink supply pin 249 improved can be easily implemented.

In addition, in this embodiment, as shown in FIG. 11, the circuit substrate 17 and the container-side fixation structure 40 are disposed in positions closer to the front end face 11 than to the rear end face 12. Then, when the ink cartridges 100 are inserted into the cartridge slots 7A to 7E, the biasing unit of the device-side fixation structure 50 biases the locking pin 37 such that the locking pin 37 presses the bottom face of the guide groove 39 of the container-side fixation structure 40 upward. In other words, the second side face 25 that becomes the lower face of the ink cartridge 100 is pressed toward the first side face 15 that becomes the top face by the locking pin 37. Accordingly, a configuration in which the contact point 17a of the circuit substrate 17 disposed on the first side face 15 of the ink cartridge 100 is tightly pressed to the device-side terminal 250 of the ink jet printing apparatus 211 (the contact points 17a and 25a approach together) is formed, whereby the electrode of the circuit substrate 17 and the device-side terminal 250 can be connected assuredly.

In particular, in this embodiment, as shown in FIG. 11, in a state in which the ink cartridges 100 are installed, that is, in a state in which the locking pin 37 is locked in the locking portion 49, the contact point 250a is brought into contact with the contact point 17a in a position closer to the front end face 11 of the ink cartridge 100 than to the position of the locking pin 37 locked in the locking portion 49 by a distance S. In this state, the locking pin 37 of the device-side fixation structure 50 presses the bottom face of the guide groove 39 of the container-side fixation structure 40 upward. Accordingly, the front end face 11 side of the ink cartridge 100 rotates about the support portion 70 of the rear-end face 12 side upward.

Then, while the contact point 17a of the electrode of the circuit substrate 17 disposed on the first side face 15 is tightly pressed to the device-side terminal 250, the contact point 17a moves to the device-side terminal 250 side with a movement amount greater than that of the bottom face of the guide groove 39 of the container-side fixation structure 40 by the locking pin 37. Accordingly, a configuration in which the contact point 17a is tightly pressed to the device-side terminal 250 is formed. Therefore, the electrode of the circuit substrate 17 and the device-side terminal 250 are connected more assuredly.

### B. Second Embodiment

FIGS. 20 to 23 are explanatory diagrams schematically showing the procedure of inserting an ink cartridge 100b into a cartridge holder 200b according to a second embodiment of the invention. The difference from the first embodiment shown in FIGS. 16 to 19 is that any inclination portion is not disposed in the position determining holes 21 and 23, and an inclination portion 247a is disposed in a position determining pin 247b, and other configurations are the same as those of the first embodiment. As described above, even when the inclination portion 247a is disposed in the position determining pin 247b, as in the first embodiment, generation of grinding powers of the surface 15 of the ink cartridge 100 or the cocking pin 18 is suppressed. Accordingly, occurrence of defective contact between terminals can be suppressed.

### C. Third Embodiment

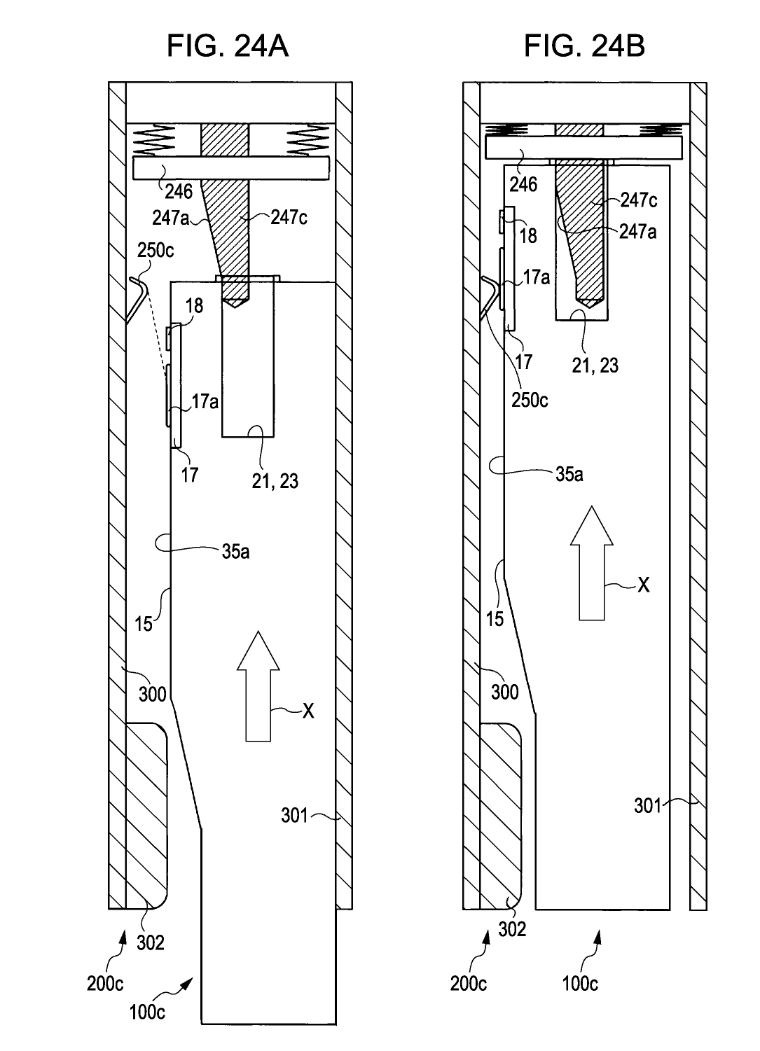

FIGS. 24A and 24B are explanatory diagrams schematically showing the procedure of inserting an ink cartridge 100c into a cartridge holder 200c according to a third embodiment of the invention. FIGS. 24A and 24B are plan views of the ink cartridge 100c, viewed from a first side face 15 (top face). FIG. 24A shows a state in the middle of inserting the ink cartridge 100c. FIG. 24B shows a state in which the ink cartridge 100c is completely inserted into the cartridge holder 200c. The differences from the first embodiment shown in FIGS. 16 to 19 are as follows.

The circuit substrate 17 is disposed on a side face 35a (third side face 35a) of the ink cartridge 100c.

Partition Walls 300 and 301 are disposed.

A device-side terminal 250c is disposed on the partition wall 300.

Any inclination portion is not disposed in position determining holes 21 and 23, and an inclination portion 247a is disposed in a position determining pin 247c.

A regulation member 302 is disposed in the partition wall 300.

The ink cartridge 100c has the front side (upper side in the figure) that has a width greater than that of the rear side.

Other configurations are the same as those of the first embodiment.

A user sets the ink cartridge 100c between the partition wall 301 and the regulation member 302 when the ink cartridge 100c is inserted into the holder 200c. Then, the ink cartridge 100 is inserted along the partition wall 301. When the position determining holes 21 and 23 start to move along the inclination portion 247a of the position determining pin 247c, the ink cartridge 100c approaches the partition wall 300 on the left side and is inserted into the cartridge holder 200c. At this time, the device-side terminal 250c is brought into contact not with the side face 35a of the ink cartridge 100 or the cocking pin 18 but with the terminal 17a (broken line W). Thus, in such a configuration, same as in the first embodiment, generation of grinding powers of a substrate ground face of the ink cartridge 100 or the cocking pin 18 is suppressed, and occurrence of defective contact between terminals can be suppressed. In addition, as in the second embodiment, the inclination portion may be formed in the position determining holes 21 and 23.

### D. Modified Examples

The invention is not limited to the above-described embodiments or examples. Thus, the invention may be performed in various forms without departing from the concept of the invention. For example, the following modifications can be made.

### D1. Modified Example 1

In each of the above-described embodiments, the inclination portion is formed either in the position determining hole or in the position determining pin. However, the inclination portion may be configured to be formed in both the position determining hole and the position determining pin.

### D2. Modified Example 2

In addition, in the above-described embodiment, an ink jet printing apparatus and an ink cartridge have been described. However, a liquid ejecting apparatus that injects or ejects liquid other than ink and a liquid container that supplies the liquid to the liquid ejecting apparatus may be implemented. The liquid described here includes a liquid body acquired by dispersing particles of functional materials into a solvent and a fluid body such as gel. For example: a liquid ejecting apparatus that ejects a liquid that contains a material such as an electrode material or a coloring material in a dispersed form or dissolved form that is used for manufacturing a liquid crystal display, an EL (electroluminescence) display, or a field emission display, a color filer, or the like; a liquid ejecting apparatus that ejects bioorganic material that is used for manufacturing a bio chip; and a liquid ejecting apparatus that is used as a precision pipette and ejects a liquid that becomes a test material. In addition, the invention may be applied to: a liquid ejecting apparatus that ejects a lubricant to a precision machine such as a clock or a camera in a pin-point manner; a liquid ejecting apparatus that ejects a transparent resin liquid such as an ultraviolet-curable resin onto a substrate for forming a tiny hemispherical lens (optical lens) used in an optical communication element or the like; a liquid ejecting apparatus that ejects an acid etching solution, alkali etching solution, or the like for etching a substrate or the like; or a liquid container supplying liquid to the above-described liquid ejecting apparatuses may be implemented. The invention may be applied to any one of the above-described ejecting apparatuses and liquid containers. Furthermore, the invention is not limited to an ink jet printer, and a laser printer that performs printing by using a printing material such as toner or a toner cartridge may be implemented.

The entire disclosure of Japanese Patent Application No. 2009-053785, filed Mar. 6, 2009 is expressly incorporated by reference herein.

What is claimed is:

1. A liquid ejecting apparatus that ejects liquid, the liquid ejecting apparatus comprising:
a liquid housing container that houses the liquid; and
a liquid ejecting apparatus main body having a container housing portion that houses the liquid housing container,
wherein the container housing portion comprises:
a first terminal that is used for electrical connection to the liquid housing container; and
a position determining pin that has a shape expanding in an insertion direction in which the liquid housing container is inserted into the container housing portion and determines the position of the liquid housing container, and
wherein the liquid housing container comprises:
a circuit substrate that has a face approximately parallel to the insertion direction and has a second terminal that is electrically connected to the first terminal by being brought into contact with each other; and
a position determining hole that determines the position of the liquid housing container by inserting the position determining pin therein,
wherein an inclination portion that is disposed to be inclined with respect to the insertion direction is formed in at least one of the position determining pin and the position determining hole,
wherein the inclination portion is configured such that the first terminal is brought into contact first with the circuit substrate by inserting the position determining pin into the position determining hole along the inclination portion when the liquid housing container is inserted into the container housing portion.

2. The liquid ejecting apparatus according to claim 1, wherein the inclination portion is configured such that a target that is brought into contact first with the first terminal is the second terminal when the liquid housing container is inserted into the container housing portion.

3. A liquid housing container that houses liquid supplied to a liquid ejecting apparatus main body,
wherein the liquid ejecting apparatus main body comprises a container housing portion that houses the liquid housing container,
wherein the container housing portion comprises:
a first terminal that is used for electrical connection to the liquid housing container; and
a position determining pin that has a shape expanding in an insertion direction in which the liquid housing container is inserted into the container housing portion and determines the position of the liquid housing container, and
wherein the liquid housing container comprises:
a circuit substrate that has a face approximately parallel to the insertion direction and has a second terminal that is electrically connected to the first terminal by being brought into contact with each other; and
a position determining hole that determines the position of the liquid housing container by inserting the position determining pin therein,
wherein an inclination portion disposed to be inclined with respect to the insertion direction is formed in the position determining hole,
wherein the inclination portion is configured such that the first terminal is brought into contact first with the circuit substrate by inserting the position determining pin into the position determining hole along the inclination portion when the liquid housing container is inserted into the container housing portion.
